(19) United States
(12) Patent Application Publication
(10) Pub. No.: US 2024/0163056 A1
(43) Pub. Date: May 16, 2024

(54) METHOD AND DEVICE USED FOR POSITIONING

(71) Applicants: Jin LIU, Shanghai (CN); Xiaobo ZHANG, Shanghai (CN)

(72) Inventors: Jin LIU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/509,330

(22) Filed: Nov. 15, 2023

(30) Foreign Application Priority Data
Nov. 16, 2022 (CN) 202211434763.8

(51) Int. Cl. H04L 5/00

(52) U.S. Cl. CPC H04L 5/0051

(57) ABSTRACT

The present application discloses a method and a device for positioning. A first node receives Q positioning reference signals respectively on Q reference signal sub-resources; a first reference signal resource uses a first configuration; the first reference signal resource comprises multiple reference signal sub-resources, and at least one of the multiple reference signal sub-resources uses a second configuration; any of the Q reference signal sub-resources is one of the multiple reference signal sub-resources comprised by the first reference signal resource; the Q positioning reference signals are respectively transmitted by Q transmitters; the Q positioning reference signals are used for determining location information of the first node; a value of Q is used to determine the second configuration. This application enhances the accuracy of Sidelink Positioning.

### CROSS REFERENCE TO RELATED APPLICATIONS

This application claims the priority benefit of Chinese Patent Application No.202211434763.8, filed on Nov. 16, 2022, the full disclosure of which is incorporated herein by reference.

### BACKGROUND

### Technical Field

The present application relates to transmission methods and devices in wireless communication systems, and in particular to a positioning-related scheme and device in wireless communications.

### Related Art

Positioning is an important aspect of application in wireless communications; the emergence of new applications of Vehicle to everything (V2X) or Industrial Internet of Things (IIoT) have posed higher demands on the accuracy or delay in respect of positioning. During the 3rd Generation Partner Project (3GPP) Radio Access Network (RAN) #94e Meetings, the project of studies on positioning enhancement has been approved.

### SUMMARY

According to the work plan of NR Release-18 (Rel-18), the technique of enhanced positioning is required for supporting Sidelink Positioning (SL Positioning), where the dominant SL positioning techniques include those based on SL RTT, SL AOA, SL TDOA and SL AOD, etc., and the performances of all these techniques are dependent on the measurement of a Sidelink Positioning Reference Signal (SL PRS). For the enhancement of SL PRS resource capacity, in most cases the SL PRS resources are non-consecutive and mutually interleaved in frequency domain. Since a User Equipment (UE) itself can choose resources for transmitting SL PRS, it is likely that SL PRS resources chosen by different UEs conflict with each other, which will have a negative impact on the positioning accuracy.

To address the above issue, the present application provides a solution for resource allocation for positioning reference signals. It should be noted that the statement in the present application only takes V2X as a typical application scenario or example; this present application is also applicable to scenarios confronting similar problems, such as Public Safety and IIoT, where technical effects similar to those of NR V2X can be achieved. Besides, the present application is originally targeted at scenarios where the transmitter of radio signals for positioning measurements is moving, for instance, a piece of User Equipment (UE), but it can still be applicable to scenarios where the transmitter of radio signals for positioning measurements is fixed, e.g., a Road Side Unit (RSU). The adoption of a unified solution for various scenarios contributes to the reduction of hardcore complexity and costs. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

Refer to 3GPP TS38.211, TS38.212, TS38.213, TS38.214, TS38.215, TS38.321, TS38.331, TS38.305, or TS37.355, if necessary, for a better understanding of the present application.

The present application provides a method in a first node for wireless communications, comprising:
receiving Q positioning reference signals respectively on Q reference signal sub-resources, Q being a positive integer greater than 1;
herein, a first resource pool comprises a first reference signal resource, the first reference signal resource using a first configuration; the first reference signal resource comprises multiple reference signal sub-resources, and at least one of the multiple reference signal sub-resources uses a second configuration, where Resource Elements (REs) occupied by any two reference signal sub-resources among the multiple reference signal sub-resources are different; any of the Q reference signal sub-resources is one of the multiple reference signal sub-resources comprised by the first reference signal resource; the Q positioning reference signals are respectively transmitted by Q transmitters; the Q positioning reference signals are used for determining location information of the first node; a value of Q is used to determine the second configuration.

In one embodiment, a problem to be solved in the present application is: SL PRS resources are non-contiguous in frequency domain and are mutually interleaved, so that conflicts are likely to occur when different UEs select SL PRS resources on their own.

In one embodiment, a problem to be solved in the present application is: the issue of resource allocation with multiple anchor nodes transmitting positioning reference signals for one target node.

In one embodiment, the method provided in the present application is: to relate sub-resources occupied by positioning reference signals transmitted by multiple anchor nodes to a reference signal resource.

In one embodiment, the method provided in the present application is: to relate the configuration of sub-resources occupied by positioning reference signals transmitted by multiple anchor nodes to the number of the multiple anchor nodes.

In one embodiment, the method in the present application helps reduce SL PRS resource conflicts.

In one embodiment, the method in the present application helps increase the accuracy of positioning.

According to one aspect of the present application, the above method is characterized in comprising:
receiving first configuration information;
herein, the first configuration information is used for determining the first resource pool; the first configuration information is used for determining K1 candidate resource configurations, with the first configuration being one of the K1 candidate resource configurations; any of the K1 candidate resource configurations comprises at least one of a comb size, a number of symbols, a number of frequency-domain resource blocks, a resource repetition factor or a number of REs, where K1 is a positive integer greater than 1.

According to one aspect of the present application, the above method is characterized in that the first configuration comprises a first comb size, while the second configuration comprises a second comb size, where the second comb size is Q times the size of the first comb size.

According to one aspect of the present application, the above method is characterized in that the first configuration comprises a first number of symbols, while the second configuration comprises a second number of symbols, where the first number of symbols is Q times the size of the second number of symbols.

According to one aspect of the present application, the above method is characterized in that a number of REs occupied by the first reference signal resource is Q times the size of a number of REs occupied by any reference signal sub-resource of the Q reference signal sub-resources.

According to one aspect of the present application, the above method is characterized in that at least one reference signal sub-resource among the multiple reference signal sub-resources comprised by the first resource pool uses a third configuration, the third configuration being one of the K1 candidate resource configurations, where the third configuration is different from the second configuration.

According to one aspect of the present application, the above method is characterized in comprising:
transmitting a first signaling;
herein, the first signaling carries a first identifier, the first identifier being associated with the first reference

signal resource; the Q transmitters correspond to Q second-type identifiers, respectively, and the Q second-type identifiers are respectively used for determining the Q reference signal sub-resources in the first reference signal resource.

According to one aspect of the present application, the above method is characterized in that the first node is a UE.

According to one aspect of the present application, the above method is characterized in that the first node is a relay node.

According to one aspect of the present application, the above method is characterized in that the first node is a Road Side Unit (RSU).

The present application provides a method in a second node for wireless communications, comprising:
transmitting a first positioning reference signal on a first reference signal sub-resource;
herein, a first resource pool comprises a first reference signal resource, the first reference signal resource using a first configuration; the first reference signal resource comprises multiple reference signal sub-resources, and at least one of the multiple reference signal sub-resources uses a second configuration, where Resource Elements (REs) occupied by any two reference signal sub-resources among the multiple reference signal sub-resources are different; the first reference signal sub-resource is one of Q reference signal sub-resources, Q being a positive integer greater than 1, and any of the Q reference signal sub-resources is one of the multiple reference signal sub-resources comprised by the first reference signal resource; the Q reference signal sub-resources are respectively used for transmitting Q positioning reference signals, with the first positioning reference signal being one of the Q positioning reference signals; the Q positioning reference signals are used for determining location information of a target receiver of the first positioning reference signal; a value of Q is used to determine the second configuration.

According to one aspect of the present application, the above method is characterized in that the first resource pool is associated with K1 candidate resource configurations, with the first configuration being one of the K1 candidate resource configurations; any of the K1 candidate resource configurations comprises at least one of a comb size, a number of symbols, a number of frequency-domain resource blocks, a resource repetition factor or a number of REs, where K1 is a positive integer greater than 1.

According to one aspect of the present application, the above method is characterized in that the first configuration comprises a first comb size, while the second configuration comprises a second comb size, where the second comb size is Q times the size of the first comb size.

According to one aspect of the present application, the above method is characterized in that the first configuration comprises a first number of symbols, while the second configuration comprises a second number of symbols, where the first number of symbols is Q times the size of the second number of symbols.

According to one aspect of the present application, the above method is characterized in that a number of REs occupied by the first reference signal resource is Q times the size of a number of REs occupied by any reference signal sub-resource of the Q reference signal sub-resources.

According to one aspect of the present application, the above method is characterized in that at least one reference signal sub-resource among the multiple reference signal sub-resources comprised by the first resource pool uses a third configuration, the third configuration being one of the K1 candidate resource configurations, where the third configuration is different from the second configuration.

According to one aspect of the present application, the above method is characterized in comprising:
receiving a first signaling;
herein, the first signaling carries a first identifier, the first identifier being associated with the first reference signal resource; the second node corresponds to one of Q second-type identifiers, where the second-type identifier corresponding to the second node among the Q second-type identifiers is used for determining the first reference signal sub-resource from the Q reference signal sub-resources.

According to one aspect of the present application, the above method is characterized in that the second node is a UE.

According to one aspect of the present application, the above method is characterized in that the second node is a relay node.

According to one aspect of the present application, the above method is characterized in that the second node is a Road Side Unit (RSU).

The present application provides a first node for wireless communications, comprising:
a first receiver, receiving Q positioning reference signals respectively on Q reference signal sub-resources, Q being a positive integer greater than 1;
herein, a first resource pool comprises a first reference signal resource, the first reference signal resource using a first configuration; the first reference signal resource comprises multiple reference signal sub-resources, and at least one of the multiple reference signal sub-resources uses a second configuration, where Resource Elements (REs) occupied by any two reference signal sub-resources among the multiple reference signal sub-resources are different; any of the Q reference signal sub-resources is one of the multiple reference signal sub-resources comprised by the first reference signal resource; the Q positioning reference signals are respectively transmitted by Q transmitters; the Q positioning reference signals are used for determining location information of the first node; a value of Q is used to determine the second configuration.

The present application provides a second node for wireless communications, comprising:
a second transmitter, transmitting a first positioning reference signal on a first reference signal sub-resource;
herein, a first resource pool comprises a first reference signal resource, the first reference signal resource using a first configuration; the first reference signal resource comprises multiple reference signal sub-resources, and at least one of the multiple reference signal sub-resources uses a second configuration, where Resource Elements (REs) occupied by any two reference signal sub-resources among the multiple reference signal sub-resources are different; the first reference signal sub-resource is one of Q reference signal sub-resources, Q being a positive integer greater than 1, and any of the Q reference signal sub-resources is one of the multiple reference signal sub-resources comprised by the first reference signal resource; the Q reference signal sub-resources are respectively used for transmitting Q positioning reference signals, with the first positioning reference signal being one of the Q positioning reference signals; the Q positioning reference signals are used for determining location information of a target receiver of the first positioning reference signal; a value of Q is used to determine the second configuration.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a structure diagram of UE positioning according to one embodiment of the present application.

FIG. 6 illustrates a flowchart of radio signal transmission according to one embodiment of the present application.

FIG. 7 illustrates a schematic diagram illustrating a relation between a first reference signal resource and Q reference signal sub-resources according to one embodiment of the present application.

FIG. 8 illustrates a schematic diagram illustrating a relation between a first reference signal resource and Q reference signal sub-resources according to one embodiment of the present application.

FIG. 9 illustrates a schematic diagram illustrating a relation between a first signaling and Q positioning reference signals according to one embodiment of the present application.

FIG. 10 illustrates a structure block diagram of a processing device used in a first node according to one embodiment of the present application.

FIG. 11 illustrates a structure block diagram of a processing device used in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

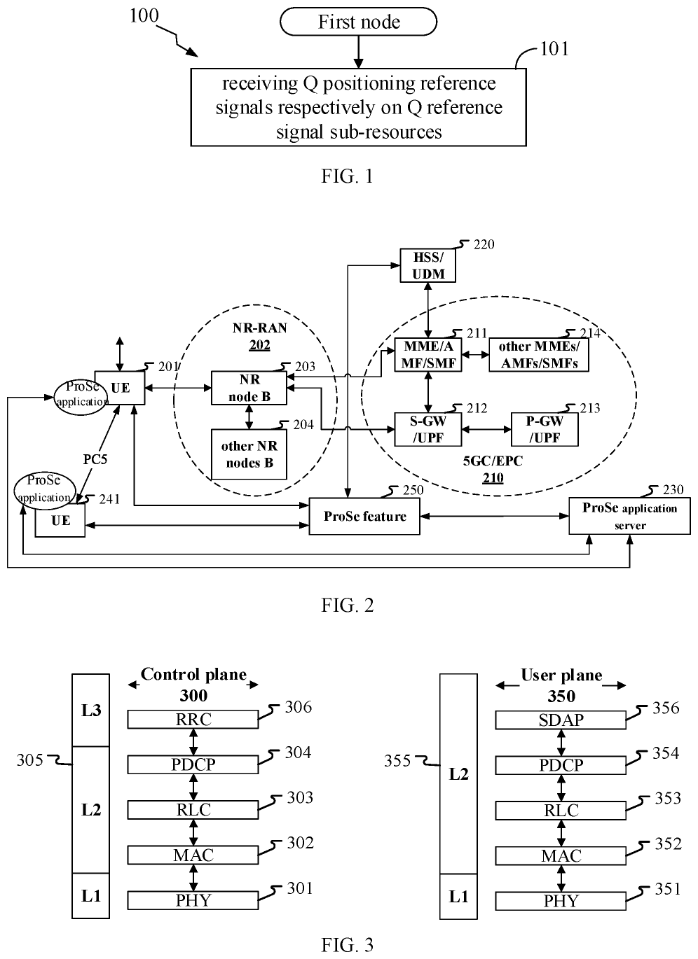

Embodiment 1 illustrates a flowchart of processing of a first node in one embodiment of the present application, as shown in FIG. 1. In FIG. 1, each box represents a step.

In Embodiment 1, the first node in the present application performs step 101, to receive Q positioning reference signals respectively on Q reference signal sub-resources, Q being a positive integer greater than 1; a first resource pool comprises a first reference signal resource, the first reference signal resource using a first configuration; the first reference signal resource comprises multiple reference signal sub-resources, and at least one of the multiple reference signal sub-resources uses a second configuration, where Resource Elements (REs) occupied by any two reference signal sub-resources among the multiple reference signal sub-resources are different; any of the Q reference signal sub-resources is one of the multiple reference signal sub-resources comprised by the first reference signal resource; the Q positioning reference signals are respectively transmitted by Q transmitters; the Q positioning reference signals are used for determining location information of the first node; a value of Q is used to determine the second configuration.

In one embodiment, the first resource pool comprises a Sidelink Resource Pool.

In one embodiment, the first resource pool is used for Sidelink Transmission.

In one embodiment, the first resource pool is used for Sidelink Communication.

In one embodiment, the first resource pool is used for Sidelink Positioning.

In one embodiment, the first resource pool is used for Sidelink Positioning Reference Signal (SL PRS/SL-PRS) transmission.

In one embodiment, the first resource pool is dedicated to SL-PRS transmission.

In one embodiment, the first resource pool is used for SL-PRS and Sidelink Control Information (SCI) transmissions.

In one embodiment, the first resource pool comprises a Physical Sidelink Control Channel (PSCCH).

In one embodiment, the first resource pool comprises a Physical Sidelink Shared Channel (PSSCH).

In one embodiment, the first resource pool comprises SL-PRS resources.

In one embodiment, the first resource pool comprises PSCCH and SL-PRS resources.

In one embodiment, the first resource pool comprises PSCCH, PSSCH and SL-PRS resources.

In one embodiment, the first resource pool comprises multiple Resource Elements (REs).

In one embodiment, any RE in the first resource pool occupies a multicarrier symbol in time domain and a subcarrier in frequency domain.

In one embodiment, the first resource pool comprises multiple time-frequency resource blocks.

In one embodiment, any time-frequency resource block among the multiple time-frequency resource blocks comprised in the first resource pool comprises multiple REs.

In one embodiment, the first resource pool comprises multiple time-domain resource blocks in time domain

In one embodiment, the first resource pool comprises multiple frequency-domain resource blocks in frequency domain

In one embodiment, time-domain resources occupied by any time-frequency resource block of the multiple time-frequency resource blocks comprised by the first resource pool in time domain are one of the multiple time-domain resource blocks comprised by the first resource pool in time domain.

In one embodiment, time-domain resources occupied by the multiple time-frequency resource blocks comprised by the first resource pool in time domain are respectively the multiple time-domain resource blocks comprised by the first resource pool in time domain.

In one embodiment, frequency-domain resources occupied by any time-frequency resource block of the multiple time-frequency resource blocks comprised by the first resource pool in frequency domain are one of the multiple frequency-domain resource blocks comprised by the first resource pool in frequency domain

In one embodiment, frequency-domain resources occupied by the multiple time-frequency resource blocks comprised by the first resource pool in frequency domain are respectively the multiple frequency-domain resource blocks comprised by the first resource pool in frequency domain.

In one embodiment, time-domain resources occupied by any time-frequency resource block of the multiple time-frequency resource blocks comprised by the first resource pool in time domain belongs to a time-domain resource block in the first resource pool, and frequency-domain resources occupied by any time-frequency resource block of the multiple time-frequency resource blocks comprised by the first resource pool in frequency domain belongs to a frequency-domain resource block in the first resource pool.

In one embodiment, the multiple time-domain resource blocks comprised by the first resource pool in time domain are respectively multiple slots.

In one embodiment, the multiple time-domain resource blocks comprised by the first resource pool in time domain are respectively multiple multicarrier symbols.

In one embodiment, any time-domain resource block among the multiple time-domain resource blocks comprised in the first resource pool in time domain belongs to a slot.

In one embodiment, any time-domain resource block among the multiple time-domain resource blocks comprised in the first resource pool in time domain comprises at least one multicarrier symbol.

In one embodiment, the multiple frequency-domain resource blocks comprised by the first resource pool in frequency domain are respectively multiple subchannels.

In one embodiment, the multiple frequency-domain resource blocks comprised by the first resource pool in frequency domain are respectively multiple Resource Blocks (RBs).

In one embodiment, the multiple frequency-domain resource blocks comprised by the first resource pool in frequency domain are respectively multiple Physical Resource Blocks (PRBs).

In one embodiment, any frequency-domain resource block among the multiple frequency-domain resource blocks comprised in the first resource pool in frequency domain belongs to a subchannel.

In one embodiment, any frequency-domain resource block among the multiple frequency-domain resource blocks comprised in the first resource pool in frequency domain belongs to an RB.

In one embodiment, any frequency-domain resource block among the multiple frequency-domain resource blocks comprised in the first resource pool in frequency domain belongs to a PRB.

In one embodiment, any frequency-domain resource block among the multiple frequency-domain resource blocks comprised by the first resource pool in frequency domain comprises at least one subcarrier.

In one embodiment, any frequency-domain resource block among the multiple frequency-domain resource blocks comprised by the first resource pool in frequency domain comprises at least one RB.

In one embodiment, any frequency-domain resource block among the multiple frequency-domain resource blocks comprised by the first resource pool in frequency domain comprises at least one PRB.

In one embodiment, the multiple time-domain resource blocks comprised by the first resource pool in time domain are respectively multiple slots, and the multiple frequency-domain resource blocks comprised by the first resource pool in frequency domain are respectively multiple PRBs.

In one embodiment, the first resource pool comprises the first time-domain resource block.

In one embodiment, the first time-domain resource block is one of the multiple time-domain resource blocks comprised by the first resource pool.

In one embodiment, the first time-domain resource block comprises at least one slot.

In one embodiment, the first time-domain resource block is a slot.

In one embodiment, the first time-domain resource block comprises multiple multicarrier symbols.

In one embodiment, the multicarrier symbol is an Orthogonal Frequency Division Multiplexing (OFDM) Symbol.

In one embodiment, the multicarrier symbol is a Single-Carrier Frequency Division Multiple Access (SC-FDMA) symbol.

In one embodiment, the multicarrier symbol is a Discrete Fourier Transform Spread Orthogonal Frequency Division Multiplexing (DFT-S-OFDM) symbol.

In one embodiment, the multicarrier symbol is an Interleaved Frequency Division Multiple Access (IFDMA) symbol.

In one embodiment, the first reference signal resource comprises multiple REs.

In one embodiment, the first reference signal resource comprises multiple REs in the first resource pool.

In one embodiment, the first reference signal resource comprises multiple subcarriers in frequency domain.

In one embodiment, the first reference signal resource comprises multiple consecutive subcarriers in frequency domain.

In one embodiment, the first reference signal resource comprises multiple equally-spaced subcarriers in frequency domain.

In one embodiment, frequency-domain resources comprised by the first reference signal resource in frequency domain occupies at least one PRB.

In one embodiment, frequency-domain resources comprised by a first reference signal resource in frequency domain occupies at least one subchannel.

In one embodiment, any two adjacent subcarriers comprised by the first reference signal resource in frequency domain are spaced by N subcarrier(s), where N is a positive integer.

In one embodiment, any two adjacent subcarriers comprised by the first reference signal resource in frequency domain are spaced by N−1 subcarrier(s), where N is a positive integer.

In one embodiment, a comb size of the first reference signal resource is N.

In one embodiment, the comb size of the first reference signal resource is a number of subcarriers between any two adjacent subcarriers comprised by the first reference signal resource in frequency domain.

In one embodiment, the comb size of the first reference signal resource is a number of subcarriers between any two adjacent subcarriers occupied by the first reference signal resource in frequency domain.

In one embodiment, N is a positive integer among 1, 2, 4, 6, 8 and 12.

In one embodiment, N is equal to 1.

In one embodiment, N is equal to 12.

In one embodiment, the first reference signal resource comprises at least one multicarrier symbol in time domain.

In one embodiment, the first reference signal resource comprises at least two consecutive multicarrier symbols in time domain.

In one embodiment, the first reference signal resource comprises M consecutive multicarrier symbols in time domain, M being a positive integer.

In one embodiment, a number of symbols of the first reference signal resource is M.

In one embodiment, the number of symbols of the first reference signal resource is a number of multicarrier symbols comprised by the first reference signal resource in time domain.

In one embodiment, the number of symbols of the first reference signal resource is a number of the multiple multicarrier symbols comprised by the first reference signal resource in time domain.

In one embodiment, the number of symbols of the first reference signal resource is a number of multiple multicarrier symbols occupied by the first reference signal resource in time domain.

In one embodiment, M is equal to N.

In one embodiment, M is less than N.

In one embodiment, M is greater than N.

In one embodiment, M is a positive integer among 2, 4, 6, 8 and 12.

In one embodiment, M is equal to 2.

In one embodiment, M is equal to 12.

In one embodiment, the first reference signal resource is used for bearing at least one positioning reference signal.

In one embodiment, the first reference signal resource is used for bearing one positioning reference signal.

In one embodiment, the first reference signal resource comprises time-frequency resources occupied by at least one positioning reference signal.

In one embodiment, the first reference signal resource is time-frequency resources occupied by one positioning reference signal.

In one embodiment, the first reference signal resource comprises REs occupied by at least one positioning reference signal.

In one embodiment, the first reference signal resource is REs occupied by one positioning reference signal.

In one embodiment, the first reference signal resource comprises at least one SL-PRS resource.

In one embodiment, the first reference signal resource is an SL-PRS resource.

In one embodiment, the first reference signal resource comprises at least one Sidelink Channel State Information Reference Signal (SL-CSI-RS) resource.

In one embodiment, the first reference signal resource comprises at least one PSSCH Demodulation Reference Signal (DMRS) resource.

In one embodiment, the first resource pool comprises the first reference signal resource.

In one embodiment, any RE of the multiple REs being comprised by the first reference signal resource is an RE in the first resource pool.

In one embodiment, the first reference signal resource belongs to a time-domain resource block in the first resource pool in time domain.

In one embodiment, the first reference signal resource belongs to a slot in time domain.

In one embodiment, a time-domain resource block in the first resource pool comprises time-domain resources comprised by the first reference signal resource in time domain.

In one embodiment, the first reference signal resource belongs to one of the multiple time-domain resource blocks comprised by the first resource pool in time domain.

In one embodiment, time-domain resources comprised by the first reference signal resource in time domain belongs to one of the multiple time-domain resource blocks comprised by the first resource pool.

In one embodiment, a time-domain resource block in the first resource pool comprises the M multicarrier symbols comprised by the first reference signal resource in time domain.

In one embodiment, any multicarrier symbol among the M multicarrier symbols comprised by the first reference signal resource in time domain is a multicarrier symbol in a time-domain resource block in the first resource pool.

In one embodiment, the first reference signal resource belongs to the first resource pool in frequency domain.

In one embodiment, the first reference signal resource belongs to a frequency-domain resource block in the first resource pool.

In one embodiment, the first reference signal resource belongs to a subchannel in frequency domain.

In one embodiment, frequency-domain resources comprised by the first reference signal resource in frequency domain belong to the first resource pool.

In one embodiment, a frequency-domain resource block in the first resource pool comprises frequency-domain resources occupied by the first reference signal resource in frequency domain.

In one embodiment, the first resource pool comprises frequency-domain resources occupied by the first reference signal resource in frequency domain.

In one embodiment, frequency-domain resources comprised by the first reference signal resource in frequency domain comprise at least one frequency-domain resource block in the first resource pool.

In one embodiment, frequency-domain resources comprised by the first reference signal resource in frequency domain comprise multiple frequency-domain resource blocks in the first resource pool.

In one embodiment, frequency-domain resources comprised by the first reference signal resource in frequency domain comprise multiple PRBs in the first resource pool.

In one embodiment, a bandwidth of the first reference signal resource is no larger than a bandwidth of the first resource pool.

In one embodiment, a bandwidth of the first reference signal resource is equal to a bandwidth of the first resource pool.

In one embodiment, a bandwidth of the first reference signal resource is smaller than a bandwidth of the first resource pool.

In one embodiment, the bandwidth of the first reference signal resource is measured in MHz.

In one embodiment, a bandwidth of the first resource pool is measured in MHz.

In one embodiment, the bandwidth of the first reference signal resource refers to a number of frequency-domain resource blocks in frequency-domain resources comprised by the first reference signal resource in frequency domain.

In one embodiment, the bandwidth of the first resource pool refers to a number of the multiple frequency-domain resource blocks comprised by the first resource pool in frequency domain.

In one embodiment, a number of frequency-domain resource blocks in frequency-domain resources comprised by the first reference signal resource in frequency domain is no greater than a number of the multiple frequency-domain resource blocks comprised by the first resource pool in frequency domain.

In one embodiment, a number of frequency-domain resource blocks in frequency-domain resources comprised by the first reference signal resource in frequency domain is equal to a number of the multiple frequency-domain resource blocks comprised by the first resource pool in frequency domain.

In one embodiment, a number of frequency-domain resource blocks in frequency-domain resources comprised by the first reference signal resource in frequency domain is less than a number of the multiple frequency-domain resource blocks comprised by the first resource pool in frequency domain.

In one embodiment, the first configuration is used to determine the first reference signal resource.

In one embodiment, the first configuration comprises at least one of a first comb size, a first number of symbols, a first number of frequency-domain resource blocks, a first resource repetition factor or a first number of REs.

In one embodiment, the first configuration comprises the first comb size.

In one embodiment, the first configuration comprises the first number of symbols.

In one embodiment, the first configuration comprises the first number of frequency-domain resource blocks.

In one embodiment, the first configuration comprises the first resource repetition factor.

In one embodiment, the first configuration comprises the first number of REs.

In one embodiment, the first reference signal resource using the first configuration comprises that the comb size of the first reference signal resource is equal to the first comb size in the first configuration.

In one embodiment, the first reference signal resource using the first configuration comprises that the comb size of the first reference signal resource is equal to the first comb size.

In one embodiment, the first reference signal resource using the first configuration comprises that N is equal to the first comb size.

In one embodiment, the first comb size is a positive integer.

In one embodiment, the first comb size is a positive integer among 1, 2, 4, 6, 8 and 12.

In one embodiment, the first comb size is 1.

In one embodiment, the first comb size is 2.

In one embodiment, the first reference signal resource using the first configuration comprises that the number of symbols of the first reference signal resource is equal to the first number of symbols in the first configuration.

In one embodiment, the first reference signal resource using the first configuration comprises that the number of symbols of the first reference signal resource is equal to the first number of symbols.

In one embodiment, the first reference signal resource using the first configuration comprises that M is equal to the first number of symbols.

In one embodiment, the first number of symbols is a positive integer.

In one embodiment, the first number of symbols is a positive integer among 2, 4, 6, 8 and 12.

In one embodiment, the first number of symbols is equal to 12.

In one embodiment, the first number of symbols is equal to 8.

In one embodiment, the first reference signal resource using the first configuration comprises that the first reference signal resource comprises multiple REs of which the total number is equal to the first number of REs in the first configuration.

In one embodiment, the first reference signal resource using the first configuration comprises that the first reference signal resource comprises multiple REs of which the total number is equal to the first number of REs.

In one embodiment, the first reference signal resource using the first configuration comprises that a number of frequency-domain resource blocks comprised by the first reference signal resource in frequency domain is equal to the first number of frequency-domain resource blocks in the first configuration.

In one embodiment, the first reference signal resource using the first configuration comprises that a number of frequency-domain resource blocks comprised by the first reference signal resource in frequency domain is equal to the first number of frequency-domain resource blocks.

In one embodiment, the first number of frequency-domain resource blocks is a positive integer.

In one embodiment, the first number of frequency-domain resource blocks is no greater than a number of frequency-domain resource blocks comprised by the first resource pool in frequency domain.

In one embodiment, the first number of frequency-domain resource blocks is equal to a number of frequency-domain resource blocks comprised by the first resource pool in frequency domain.

In one embodiment, the first number of frequency-domain resource blocks is less than a number of frequency-domain resource blocks comprised by the first resource pool in frequency domain.

In one embodiment, the first reference signal resource using the first configuration comprises that a resource repetition factor of the first reference signal resource in time domain is equal to the first resource repetition factor in the first configuration.

In one embodiment, the first reference signal resource using the first configuration comprises that a resource repetition factor of the first reference signal resource in time domain is equal to the first resource repetition factor.

In one embodiment, any reference signal sub-resource among the multiple reference signal sub-resources comprises multiple REs.

In one embodiment, any reference signal sub-resource among the multiple reference signal sub-resources comprises multiple REs in the first resource pool.

In one embodiment, any reference signal sub-resource among the multiple reference signal sub-resources comprises multiple subcarriers in frequency domain.

In one embodiment, any reference signal sub-resource among the multiple reference signal sub-resources comprises multiple consecutive subcarriers in frequency domain.

In one embodiment, any reference signal sub-resource among the multiple reference signal sub-resources comprises multiple equally spaced subcarriers in frequency domain.

In one embodiment, any two reference signal sub-resources among the multiple reference signal sub-resources respectively comprise two adjacent subcarriers with an equal space in between in frequency domain.

In one embodiment, at least two reference signal sub-resources among the multiple reference signal sub-resources respectively comprise two adjacent subcarriers with unequal spaces in between in frequency domain.

In one embodiment, any two adjacent subcarriers comprised by any reference signal sub-resource among the multiple reference signal sub-resources in frequency domain are spaced by N1 subcarrier(s), N1 being a positive integer.

In one embodiment, any two adjacent subcarriers comprised by any reference signal sub-resource among the multiple reference signal sub-resources in frequency domain are spaced by N1−1 subcarrier(s), N1 being a positive integer.

In one embodiment, a comb size of any reference signal sub-resource among the multiple reference signal sub-resources is N1.

In one embodiment, N1 is a positive integer among 1, 2, 4, 6, 8 and 12.

In one embodiment, any two adjacent subcarriers comprised by any reference signal sub-resource among the multiple reference signal sub-resources in frequency domain are spaced by N1 subcarrier(s), while any other two adjacent subcarriers comprised by any reference signal sub-resource among the multiple reference signal sub-resources in frequency domain are spaced by N2 subcarrier(s), where N1 and N2 are both positive integers, N1 being unequal to N2.

In one embodiment, any two adjacent subcarriers comprised by at least one reference signal sub-resource among the multiple reference signal sub-resources in frequency domain are spaced by N1−1 subcarrier(s), while any other two adjacent subcarriers comprised by at least one reference signal sub-resource among the multiple reference signal sub-resources in frequency domain are spaced by N2−1 subcarrier(s), where N1 and N2 are both positive integers, N1 being unequal to N2.

In one embodiment, a comb size of at least one reference signal sub-resource among the multiple reference signal sub-resources is N1, while a comb size of at least one reference signal sub-resource among the multiple reference signal sub-resources is N2.

In one embodiment, N2 is a positive integer among 1, 2, 4, 6, 8 and 12.

In one embodiment, the comb size of any reference signal sub-resource among the multiple reference signal sub-resources is a number of subcarriers between any two adjacent subcarriers comprised by the reference signal sub-resource among the multiple reference signal sub-resources in frequency domain.

In one embodiment, the comb size of any reference signal sub-resource among the multiple reference signal sub-resources is a number of subcarriers between any two adjacent subcarriers occupied by the reference signal sub-resource among the multiple reference signal sub-resources in frequency domain

In one embodiment, frequency-domain resources comprised by any reference signal sub-resource among the multiple reference signal sub-resources in frequency domain occupy at least one PRB.

In one embodiment, frequency-domain resources comprised by any reference signal sub-resource among the multiple reference signal sub-resources in frequency domain occupy at least one subchannel.

In one embodiment, any reference signal sub-resource among the multiple reference signal sub-resources comprises at least one multicarrier symbol in time domain.

In one embodiment, any reference signal sub-resource among the multiple reference signal sub-resources comprises at least two consecutive multicarrier symbols in time domain.

In one embodiment, any reference signal sub-resource among the multiple reference signal sub-resources comprises M1 multicarrier symbols, M1 being a positive integer.

In one embodiment, a number of symbols of any reference signal sub-resource among the multiple reference signal sub-resources is M1.

In one embodiment, M1 is a positive integer among 2, 4, 6, 8 and 12.

In one embodiment, at least one reference signal sub-resource of the multiple reference signal sub-resources comprises M1 multicarrier symbols in time domain, while at least one reference signal sub-resource of the multiple reference signal sub-resources comprises M2 multicarrier symbols in time domain, where M1 and M2 are both positive integers, and M1 is unequal to M2.

In one embodiment, M2 is a positive integer among 2, 4, 6, 8 and 12.

In one embodiment, the number of symbols of any reference signal sub-resource among the multiple reference signal sub-resources is a number of multicarrier symbols comprised by the reference signal sub-resource among the multiple reference signal sub-resources in time domain.

In one embodiment, the number of symbols of any reference signal sub-resource among the multiple reference signal sub-resources is a number of multiple multicarrier symbols occupied by the reference signal sub-resource among the multiple reference signal sub-resources in time domain.

In one embodiment, the multiple reference signal sub-resources are respectively used for bearing the Q positioning reference signals.

In one embodiment, the multiple reference signal sub-resources are respectively time-frequency resources occupied by the Q positioning reference signals.

In one embodiment, the multiple reference signal sub-resources are respectively REs occupied by the Q positioning reference signals.

In one embodiment, any reference signal sub-resource among the multiple reference signal sub-resources is an SL-PRS resource.

In one embodiment, any reference signal sub-resource among the multiple reference signal sub-resources is an SL-CSI-RS resource.

In one embodiment, any reference signal sub-resource among the multiple reference signal sub-resources is a PSSCH DMRS resource.

In one embodiment, the first resource pool comprises the multiple reference signal sub-resources.

In one embodiment, any RE of the multiple REs comprised by any reference signal sub-resource among the multiple reference signal sub-resources is an RE in the first resource pool.

In one embodiment, the first reference signal resource comprises the multiple reference signal sub-resources.

In one embodiment, time-domain resources comprised by the first reference signal resource in time domain comprise time-domain resources comprised by any reference signal sub-resource among the multiple reference signal sub-resources in time domain.

In one embodiment, frequency-domain resources comprised by the first reference signal resource in frequency domain comprise frequency-domain resources comprised by any reference signal sub-resource among the multiple reference signal sub-resources in frequency domain.

In one embodiment, any RE of the multiple REs comprised by any reference signal sub-resource among the multiple reference signal sub-resources is an RE in the first reference signal resource.

In one embodiment, time-domain resources comprised by any reference signal sub-resource among the multiple reference signal sub-resources in time domain belongs to time-domain resources comprised by the first reference signal resource in time domain.

In one embodiment, frequency-domain resources comprised by any reference signal sub-resource among the multiple reference signal sub-resources in frequency domain belongs to frequency-domain resources comprised by the first reference signal resource in frequency domain.

In one embodiment, multicarrier symbol(s) comprised by any reference signal sub-resource among the multiple reference signal sub-resources in time domain is(are) a subset of multicarrier symbol(s) comprised by the first reference signal resource in time domain.

In one embodiment, subcarrier(s) comprised by any reference signal sub-resource among the multiple reference signal sub-resources in frequency domain is(are) a subset of subcarrier(s) comprised by the first reference signal resource in frequency domain.

In one embodiment, a bandwidth of any reference signal sub-resource among the multiple reference signal sub-resources is no larger than a bandwidth of the first reference signal resource.

In one embodiment, REs comprised by any reference signal sub-resource among the multiple reference signal sub-resources are a subset of REs comprised by the first reference signal resource.

In one embodiment, any two reference signal sub-resources among the multiple reference signal sub-resources occupy REs that are different.

In one embodiment, any two reference signal sub-resources among the multiple reference signal sub-resources are orthogonal.

In one embodiment, any two reference signal sub-resources among the multiple reference signal sub-resources are time-frequency orthogonal.

In one embodiment, any two reference signal sub-resources among the multiple reference signal sub-resources are non-overlapping.

In one embodiment, a first candidate reference signal sub-resource and a second candidate reference signal sub-resource are any two reference signal sub-resources among the multiple reference signal sub-resources.

In one embodiment, any RE of REs occupied by the first candidate reference signal sub-resource does not belong to REs occupied by the second candidate reference signal sub-resource.

In one embodiment, any RE of REs occupied by the first candidate reference signal sub-resource is different from any RE of REs occupied by the second candidate reference signal sub-resource.

In one embodiment, the second configuration is used to determine the multiple reference signal sub-resources comprised by the first reference signal resource.

In one embodiment, the second configuration is used to determine the Q reference signal sub-resources.

In one embodiment, the second configuration is used to determine the Q reference signal sub-resources comprised by the first reference signal resource.

In one embodiment, the second configuration comprises at least one of a second comb size, a second number of symbols, a second number of frequency-domain resource blocks, a second resource repetition factor or a second number of REs.

In one embodiment, the second configuration comprises the second comb size.

In one embodiment, the second configuration comprises the second number of symbols.

In one embodiment, the second configuration comprises the second number of frequency-domain resource blocks.

In one embodiment, the second configuration comprises the second resource repetition factor.

In one embodiment, the second configuration comprises the second number of REs.

In one embodiment, at least one reference signal sub-resource among the multiple reference signal sub-resources using the second configuration comprises that the comb size of the at least one reference signal sub-resource among the multiple reference signal sub-resources is equal to the second comb size in the second configuration.

In one embodiment, at least one reference signal sub-resource among the multiple reference signal sub-resources using the second configuration comprises that the comb size of the at least one reference signal sub-resource among the multiple reference signal sub-resources is equal to the second comb size.

In one embodiment, at least one reference signal sub-resource among the multiple reference signal sub-resources using the second configuration comprises that N1 is equal to the second comb size.

In one embodiment, the second comb size is a positive integer.

In one embodiment, the second comb size is a positive integer among 1, 2, 4, 6, 8 and 12.

In one embodiment, the second comb size is no smaller than the first comb size.

In one embodiment, the second comb size is equal to the first comb size.

In one embodiment, the second comb size is larger than the first comb size.

In one embodiment, at least one reference signal sub-resource among the multiple reference signal sub-resources using the second configuration comprises that the number of symbols of the at least one reference signal sub-resource among the multiple reference signal sub-resources is equal to the second number of symbols in the second configuration.

In one embodiment, at least one reference signal sub-resource among the multiple reference signal sub-resources using the second configuration comprises that the number of symbols of the at least one reference signal sub-resource among the multiple reference signal sub-resources is equal to the second number of symbols.

In one embodiment, at least one reference signal sub-resource among the multiple reference signal sub-resources using the second configuration comprises that M1 is equal to the second number of symbols.

In one embodiment, the second number of symbols is a positive integer.

In one embodiment, the second number of symbols is a positive integer among 2, 4, 6, 8 and 12.

In one embodiment, the second number of symbols is no greater than the first number of symbols.

In one embodiment, the second number of symbols is equal to the first number of symbols.

In one embodiment, the second number of symbols is less than the first number of symbols.

In one embodiment, at least one reference signal sub-resource among the multiple reference signal sub-resources using the second configuration comprises that the number of the multiple REs comprised by the at least one reference signal sub-resource among the multiple reference signal sub-resources is equal to the second number of REs in the second configuration.

In one embodiment, at least one reference signal sub-resource among the multiple reference signal sub-resources using the second configuration comprises that the number of the multiple REs comprised by the at least one reference signal sub-resource among the multiple reference signal sub-resources is equal to the second number of REs.

In one embodiment, the second number of REs is a positive integer.

In one embodiment, the second number of REs is no greater than the first number of REs.

In one embodiment, the second number of REs is equal to the first number of REs.

In one embodiment, the second number of REs is less than the first number of REs.

In one embodiment, at least one reference signal sub-resource among the multiple reference signal sub-resources using the second configuration comprises that the number of frequency-domain resource blocks comprised by the at least one reference signal sub-resource among the multiple reference signal sub-resources in frequency domain is equal to the second number of frequency-domain resource blocks in the second configuration.

In one embodiment, at least one reference signal sub-resource among the multiple reference signal sub-resources using the second configuration comprises that the number of frequency-domain resource blocks comprised by the at least one reference signal sub-resource among the multiple reference signal sub-resources in frequency domain is equal to the second number of frequency-domain resource blocks.

In one embodiment, the second number of frequency-domain resource blocks is a positive integer.

In one embodiment, the second number of frequency-domain resource blocks is no greater than the first number of frequency-domain resource blocks.

In one embodiment, the second number of frequency-domain resource blocks is equal to the first number of frequency-domain resource blocks.

In one embodiment, the second number of frequency-domain resource blocks is less than the first number of frequency-domain resource blocks.

In one embodiment, at least one reference signal sub-resource among the multiple reference signal sub-resources using the second configuration comprises that the resource repetition factor of the at least one reference signal sub-resource among the multiple reference signal sub-resources in time domain is equal to the second resource repetition factor in the second configuration.

In one embodiment, at least one reference signal sub-resource among the multiple reference signal sub-resources using the second configuration comprises that the resource repetition factor of the at least one reference signal sub-resource among the multiple reference signal sub-resources in time domain is equal to the second resource repetition factor.

In one embodiment, the second configuration is different from the first configuration.

In one embodiment, the second comb size in the second configuration is larger than the first comb size in the first configuration.

In one embodiment, the second number of symbols in the second configuration is less than the first number of symbols in the first configuration.

In one embodiment, the second number of REs in the second configuration is less than the first number of REs in the first configuration.

In one embodiment, the second number of frequency-domain resource blocks in the second configuration is less than the first number of frequency-domain resource blocks in the first configuration.

In one embodiment, the second resource repetition factor in the second configuration is smaller than the first resource repetition factor in the first configuration.

In one embodiment, the Q positioning reference signals are respectively transmitted by the Q transmitters.

In one embodiment, the Q reference signal sub-resources are respectively used for transmitting the Q positioning reference signals.

In one embodiment, time-frequency resources occupied by the Q positioning reference signals are respectively the Q reference signal sub-resources.

In one embodiment, the Q transmitters are respectively Q anchor nodes.

In one embodiment, the Q transmitters include at least one UE.

In one embodiment, the Q transmitters include at least one RSU.

In one embodiment, the Q transmitters include at least one RSU and at least one UE.

In one embodiment, at least one of the Q transmitters is an RSU.

In one embodiment, at least one of the Q transmitters is a UE.

In one embodiment, the Q transmitters are respectively Q UEs.

In one embodiment, a first candidate positioning reference signal is any positioning reference signal among the Q positioning reference signals.

In one embodiment, the first candidate positioning reference signal is used for Positioning.

In one embodiment, the first candidate positioning reference signal is used for Sidelink Positioning.

In one embodiment, the first candidate positioning reference signal is used for Location Information.

In one embodiment, the first candidate positioning reference signal is used for obtaining a Rx-Tx Time Difference.

In one embodiment, the first candidate positioning reference signal is used for obtaining a Sidelink Rx-Tx Time Difference.

In one embodiment, the first candidate positioning reference signal is used for obtaining a UE Rx-Tx Time Difference.

In one embodiment, the first candidate positioning reference signal is used for obtaining a reception timing for the first candidate positioning reference signal.

In one embodiment, the first candidate positioning reference signal is used by a receiver of the first candidate positioning reference signal for obtaining a reception timing for a subframe.

In one embodiment, the first candidate positioning reference signal is used by a receiver of the first candidate positioning reference signal for obtaining a reception timing for a slot.

In one embodiment, the first candidate positioning reference signal is used for positioning measurement.

In one embodiment, the first candidate positioning reference signal is used for Sidelink positioning measurement.

In one embodiment, the first candidate positioning reference signal is used for obtaining an Angle-of-Arrival (AoA).

In one embodiment, the first positioning reference signal is used for obtaining a Reference Signal Received Power (RSRP).

In one embodiment, the first candidate positioning reference signal is used for obtaining a Reference Signal Received Path Power (RSRPP).

In one embodiment, the first candidate positioning reference signal is used for obtaining a Reference Signal Time Difference (RSTD).

In one embodiment, the first candidate positioning reference signal is used for obtaining a Relative Time of Arrival (RTOA).

In one embodiment, the first candidate positioning reference signal is used for obtaining a SL-RTOA.

In one embodiment, the first candidate positioning reference signal is used for RTT positioning.

In one embodiment, the first candidate positioning reference signal is used for Single-sided RTT positioning.

In one embodiment, the first candidate positioning reference signal is used for Double-sided RTT positioning.

In one embodiment, the first candidate positioning reference signal is configured by a Location Management Function (LMF).

In one embodiment, the first candidate positioning reference signal is configured by a g-Node-B (gNB).

In one embodiment, the first candidate positioning reference signal is configured by a Cell.

In one embodiment, the first candidate positioning reference signal is configured by a UE.

In one embodiment, the first candidate positioning reference signal includes a Sidelink Reference Signal (SL RS).

In one embodiment, the first candidate positioning reference signal includes a Sidelink Positioning Reference Signal (SL PRS).

In one embodiment, the first candidate positioning reference signal includes a Sounding Reference Signal (SRS).

In one embodiment, the first candidate positioning reference signal includes a Sidelink Primary Synchronization Signal (S-PSS).

In one embodiment, the first candidate positioning reference signal includes a Sidelink Secondary Synchronization Signal (S-SSS).

In one embodiment, the first candidate positioning reference signal includes a Physical Sidelink Broadcast Channel Demodulation Reference Signal (PSBCH DMRS).

In one embodiment, the first candidate positioning reference signal includes a Sidelink Channel State Information-Reference Signal (SL CSI-RS).

In one embodiment, the Q positioning reference signals respectively comprise Q first-type sequences.

In one embodiment, the first candidate positioning reference signal includes a first sequence, the first sequence being one of the Q first-type sequences.

In one embodiment, the Q first-type sequences are respectively used for generating the Q positioning reference signals.

In one embodiment, any first-type sequence among the Q first-type sequences is a Pseudo-Random Sequence.

In one embodiment, any first-type sequence among the Q first-type sequences is a Gold sequence.

In one embodiment, any first-type sequence among the Q first-type sequences is a Zadeoff-Chu (ZC) sequence.

In one embodiment, one of the Q positioning reference signals is obtained by any first-type sequence among the Q first-type sequences sequentially through Sequence Generation, Discrete Fourier Transform (DFT), Modulation, Resource Element Mapping, and Wideband Symbol Generation.

In one embodiment, one of the Q positioning reference signals is obtained by any first-type sequence among the Q first-type sequences sequentially through Sequence Generation, Resource Element Mapping, and Wideband Symbol Generation.

In one embodiment, the Q positioning reference signals are used for determining the location information of the first node.

In one embodiment, at least one positioning reference signal of the Q positioning reference signals is used for determining the location information of the first node.

In one embodiment, any positioning reference signal of the Q positioning reference signals is used for determining the location information of the first node.

In one embodiment, the location information of the first node is reported to a Location Management Function (LMF).

In one embodiment, the location information of the first node is transmitted to a transmitter of the first positioning reference signal.

In one embodiment, the location information of the first node is reported to a LMF by a transmitter of the first positioning reference signal.

In one embodiment, the location information of the first node is transmitted to a first node in the present application.

In one embodiment, the location information of the first node is reported to a LMF by the first node in the present application.

In one embodiment, the location information of the first node is used to determine a Round Trip Time (RTT).

In one embodiment, the location information of the first node is used by a LMF to determine an RTT.

In one embodiment, the location information of the first node is used for positioning.

In one embodiment, the location information of the first node is used for Location related measurement.

In one embodiment, the location information of the first node is used for Sidelink positioning.

In one embodiment, the location information of the first node is used to determine a Propagation Delay.

In one embodiment, the location information of the first node is used by the LMF for determining a Propagation Delay.

In one embodiment, the location information of the first node is used for RTT positioning.

In one embodiment, the location information of the first node is used for Single-sided RTT positioning.

In one embodiment, the location information of the first node is used for Double-sided RTT positioning.

In one embodiment, the location information of the first node is used for Multiple-Round Trip Time (Multi-RTT) positioning.

In one embodiment, the location information of the first node comprises a first Rx-Tx Time Difference.

In one embodiment, the first positioning reference signal is measured for obtaining the first Rx-Tx Time Difference.

In one embodiment, the first positioning reference signal is measured for obtaining the location information of the first node.

In one embodiment, the first Rx-Tx Time Difference is used for generating the location information of the first node.

In one embodiment, the location information of the first node comprises a Location related measurement.

In one embodiment, the location information of the first node comprises a Location estimate.

In one embodiment, the location information of the first node comprises Positioning Assistance Data.

In one embodiment, the location information of the first node comprises TimingQuality.

In one embodiment, the location information of the first node comprises a RxBeamIndex

In one embodiment, the location information of the first node comprises Rx power information.

In one embodiment, the location information of the first node is used for transferring Non-Access-Stratum-specific (NAS-specific) information.

In one embodiment, the location information of the first node is used for transferring timing information of the clock.

In one embodiment, the Rx power information comprises a Reference Signal Received Power (RSRP) of the first positioning reference signal.

In one embodiment, the Rx power information comprises a Reference Signal Received Path Power (RSRPP) of the first positioning reference signal.

In one embodiment, the Rx power information comprises a RSRP-ResultDiff.

In one embodiment, the Rx power information is measured in dBm.

In one embodiment, the Rx power information is measured in dB.

In one embodiment, the first Rx-Tx Time Difference includes a Reference Signal Time Difference (RSTD).

In one embodiment, the first Rx-Tx Time Difference includes a Sidelink Rx-Tx Time Difference.

In one embodiment, the first Rx-Tx Time Difference includes a UE Rx-Tx Time Difference.

In one embodiment, the first Rx-Tx Time Difference includes a RxTxTimeDiff.

In one embodiment, the first Rx-Tx Time Difference includes a SL-RxTxTimeDiff.

In one embodiment, the first Rx-Tx Time Difference includes a Relative Time of Arrival (RTOA).

In one embodiment, the first Rx-Tx Time Difference includes a SL-RTOA.

### Embodiment 2

Embodiment 2 illustrates a schematic diagram of a network architecture according to one embodiment of the present application, as shown in FIG. 2. FIG. 2 illustrates a V2X communication architecture of 5G New Radio (NR), Long-Term Evolution (LTE), and Long-Term Evolution Advanced (LTE-A) systems. The 5G NR or LTE network architecture may be called a 5G System/Evolved Packet System (5GS/EPS) 200 or other appropriate terms.

The V2X communication architecture in Embodiment 2 may comprise a UE 201, a UE241, an NG-RAN 202, a 5G Core Network/Evolved Packet Core (5GC/EPC) 210, a Home Subscriber Server/Unified Data Management (HSS/UDM) 220, a ProSe feature250 and ProSe application server 230. The V2X communication architecture may be interconnected with other access networks. For simple description, the entities/interfaces are not shown. As shown in FIG. 2, the V2X communication architecture provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPS), multimedia devices, video devices, digital audio players (for example, MP3 players), cameras, games consoles, unmanned aerial vehicles, air vehicles, narrow-band physical network equipment, machine-type communication equipment, land vehicles, automobiles, wearables, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an S1/NG interface. The 5G-CN/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services. The ProSe feature 250 refers to logical functions of network-related actions needed for Proximity-based Service (ProSe), including Direct Provisioning Function (DPF), Direct Discovery Name Management Function and EPC-level Discovery ProSe Function. The ProSe application server 230 is featured with functions like storing EPC ProSe user ID, and mapping between an application-layer user ID and an EPC ProSe user ID as well as allocating ProSe-restricted code-suffix pool.

In one embodiment, the UE201 and the UE241 are connected by a PC5 Reference Point.

In one embodiment, the ProSe feature 250 is connected to the UE 201 and the UE 241 respectively by PC3 Reference Points.

In one embodiment, the ProSe feature 250 is connected to the ProSe application server 230 by a PC2 Reference Point.

In one embodiment, the ProSe application server 230 is connected with the ProSe application of the UE 201 and the ProSe application of the UE 241 respectively via a PC1 Reference Point.

In one embodiment, the first node in the present application is the UE 201, and the second node in the present application is the UE241.

In one embodiment, the first node in the present application is the UE 241, and the second node in the present application is the UE201.

In one embodiment, a radio link between the UE 201 and the UE 241 corresponds to a sidelink (SL) in the present application.

In one embodiment, a radio link from the UE 201 to the NR Node B is an uplink.

In one embodiment, a radio link from the NR Node B to the UE 201 is a downlink

In one embodiment, the UE 201 supports SL transmission.

In one embodiment, the UE 241 supports SL transmission.

In one embodiment, the gNB 203 is a MacroCellular base station.

In one embodiment, the gNB203 is a Micro Cell base station.

In one embodiment, the gNB 203 is a PicoCell base station.

In one embodiment, the gNB203 is a Femtocell.

In one embodiment, the gNB203 is a base station supporting large time-delay difference.

In one embodiment, the gNB203 is a RoadSide Unit (RSU).

In one embodiment, the gNB203 includes satellite equipment.

### Embodiment 3

Embodiment 3 illustrates a schematic diagram of an embodiment of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, or RSU in V2X, vehicle-mounted equipment or vehicle-mounted communication module) and a second node (gNB, UE, or RSU in V2X, vehicle-mounted equipment or vehicle-mounted communication module), or between two UEs is represented by three layers, which are: Layer 1, layer 2 and layer 3. The layer 1(L1) is the lowest layer which performs signal processing functions of various PHY layers. The L1 is called PHY 301 in the present application. The layer 2 (L2) 305 is above the PHY 301, and is in charge of the link between the first node and the second node, and between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second nodes. The PDCP sublayer 304 provides data encryption and integrity protection, and provides support for handover of a first node between second nodes. The RLC sublayer 303 provides segmentation and reassembling of a packet, retransmission of a missing packet via ARQ, as well as support for detections over repeated packets and protocol errors. The MAC sublayer 302 provides mapping between a logical channel and a transport channel and multiplexing of logical channels. The MAC sublayer 302 is also responsible for allocating between first nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first node may comprise several upper layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first positioning reference signal in the present application is generated by the PHY 301.

### Embodiment 4

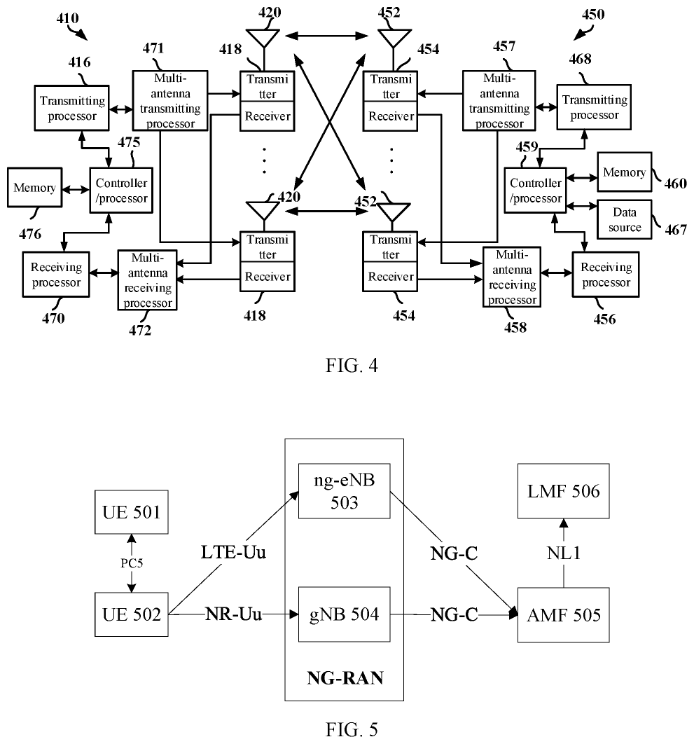

Embodiment 4 illustrates a schematic diagram of a first communication device and a second communication device according to the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In the transmission from the first communication device 410 to the second communication device 450, the controller/processor 475 provides header compression, encryption, packet segmentation and reordering, and multiplexing between a logical channel and a transport channel, and radio resource allocation of the second communication device 450 based on various priorities. The controller/processor 475 is also in charge of a retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any spatial stream targeting the second communication device 450. Symbols on each spatial stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication node 410 to the second communication node 450, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for a retransmission of a lost packet, and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission between the second communication device 450 and the first communication device 410, the controller/processor 475 provides de-multiplexing between a transport channel and a logical channel, packet reassembling, decrypting, header decompression, control signal processing so as to recover a higher-layer packet from the second communication device (UE) 450. The higher-layer packet coming from the controller/processor 475 may be provided to the core network.

In one embodiment, the second communication device 450 comprises at least one processor and at least one memory, the at least one memory comprises computer program codes; the at least one memory and the computer program codes are configured to be used in collaboration with the at least one processor. The second communication device 450 at least: receives Q positioning reference signals respectively on Q reference signal sub-resources, Q being a positive integer greater than 1; a first resource pool comprises a first reference signal resource, the first reference signal resource using a first configuration; the first reference signal resource comprises multiple reference signal sub-resources, and at least one of the multiple reference signal sub-resources uses a second configuration, where Resource Elements (REs) occupied by any two reference signal sub-resources among the multiple reference signal sub-resources are different; any of the Q reference signal sub-resources is one of the multiple reference signal sub-resources comprised by the first reference signal resource; the Q positioning reference signals are respectively transmitted by Q transmitters; the Q positioning reference signals are used for determining location information of the first node; a value of Q is used to determine the second configuration.

In one embodiment, the second communication device 450 comprises a memory that stores a computer readable instruction program, the computer readable instruction program generates actions when executed by at least one processor, which include: receiving Q positioning reference signals respectively on Q reference signal sub-resources, Q being a positive integer greater than 1; a first resource pool comprises a first reference signal resource, the first reference signal resource using a first configuration; the first reference signal resource comprises multiple reference signal sub-resources, and at least one of the multiple reference signal sub-resources uses a second configuration, where Resource Elements (REs) occupied by any two reference signal sub-resources among the multiple reference signal sub-resources are different; any of the Q reference signal sub-resources is one of the multiple reference signal sub-resources comprised by the first reference signal resource; the Q positioning reference signals are respectively transmitted by Q transmitters; the Q positioning reference signals are used for determining location information of the first node; a value of Q is used to determine the second configuration.

In one embodiment, the first communication device 410 comprises at least one processor and at least one memory, the at least one memory comprises computer program codes; the at least one memory and the computer program codes are configured to be used in collaboration with the at least one processor. The first communication device 410 at least: transmits a first positioning reference signal on a first reference signal sub-resource; a first resource pool comprises a first reference signal resource, the first reference signal resource using a first configuration; the first reference signal resource comprises multiple reference signal sub-resources, and at least one of the multiple reference signal sub-resources uses a second configuration, where Resource Elements (REs) occupied by any two reference signal sub-resources among the multiple reference signal sub-resources are different; the first reference signal sub-resource is one of Q reference signal sub-resources, Q being a positive integer greater than 1, and any of the Q reference signal sub-resources is one of the multiple reference signal sub-resources comprised by the first reference signal resource; the Q reference signal sub-resources are respectively used for transmitting Q positioning reference signals, with the first positioning reference signal being one of the Q positioning reference signals; the Q positioning reference signals are used for determining location information of a target receiver of the first positioning reference signal; a value of Q is used to determine the second configuration.

In one embodiment, the first communication device 410 comprises a memory that stores a computer readable instruction program, the computer readable instruction program generates actions when executed by at least one processor, which include: transmitting a first positioning reference signal on a first reference signal sub-resource; a first resource pool comprises a first reference signal resource, the first reference signal resource using a first configuration; the first reference signal resource comprises multiple reference signal sub-resources, and at least one of the multiple reference signal sub-resources uses a second configuration, where Resource Elements (REs) occupied by any two reference signal sub-resources among the multiple reference signal sub-resources are different; the first reference signal sub-resource is one of Q reference signal sub-resources, Q being a positive integer greater than 1, and any of the Q reference signal sub-resources is one of the multiple reference signal sub-resources comprised by the first reference signal resource; the Q reference signal sub-resources are respectively used for transmitting Q positioning reference signals, with the first positioning reference signal being one of the Q positioning reference signals; the Q positioning reference signals are used for determining location information of a target receiver of the first positioning reference signal; a value of Q is used to determine the second configuration.

In one embodiment, the second communication device 450 corresponds to the first node in the present application.

In one embodiment, the first communication device 410 corresponds to the second node in the present application.

In one embodiment, the second communication device 450 is a UE.

In one embodiment, the first communication device 410 is a UE.

In one embodiment, the second communication device 450 is an RSU.

In one embodiment, the first communication device 410 is an RSU.

In one embodiment, at least one of the antenna 452, the receiver 454, the multi-antenna receiving processor 458, the receiving processor 456, the controller/processor 459, or the memory 460 is used for receiving Q positioning reference signals respectively on Q reference signal sub-resources in the present application, where Q is a positive integer greater than 1.

In one embodiment, at least one of the antenna 452, the receiver 454, the multi-antenna receiving processor 458, the receiving processor 456, the controller/processor 459, or the memory 460 is used for receiving first configuration information in the present application.

In one embodiment, at least one of the antenna 452, the transmitter 454, the multi-antenna transmitting processor 457, the transmitting processor 468, the controller/processor 459, the memory 460 or the data source 467 is used for transmitting a first signaling in the present application.

In one embodiment, at least one of the antenna 420, the transmitter 418, the multi-antenna transmitting processor 471, the transmitting processor 416, the controller/processor 475 or the memory 476 is used for transmitting a first positioning reference signal on a first reference signal sub-resource in the present application.

In one embodiment, at least one of the antenna 420, the receiver 418, the multi-antenna receiving processor 472, the receiving processor 470, the controller/processor 475, or the memory 476 is used for receiving a first signaling in the present application.

### Embodiment 5

Embodiment 5 illustrates a structure diagram of UE positioning according to one embodiment of the present application, as shown in FIG. 5.

A UE501 is in communication with a UE502 via a PC5 interface; the UE 502 is in communication with a ng-eNB503 or gNB504 via a Long Term Evolution (LTE)-Uu interface or New Radio (NR)-Uu interface; the ng-eNB503 and the gNB 504 are sometimes called base stations, and they can also be called Next Generation (NG)-Radio Access Network (RAN). The ng-eNB503 and the gNB 504 are connected to an Authentication Management Field (AMF) 505 respectively via a Next Generation (NG)-Control(C) plane; the AMF505 is connected to a Location Management Function (LMF) 506 via a NL1 interface.

The AMF505 receives from another entity, for instance a Gateway Mobile Location Centre (GMLC) or UE, a request for location service associated with a specific UE, or the AMF505 itself decides to start the location service associated with the specific UE; and then the AMF505 sends a location service request to a LMF, e.g., the LMF506; the LMF then processes the location service request, including sending assistance data to the specific UE to assist with UE-based or UE-assisted positioning as well as receiving Location information reported from the UE; after that the LMF will return the result of the location service to the AMF505; if the location service is requested by another entity, the AMF505 will return such result to the entity.

In one embodiment, the network device in the present application includes an LMF.

In one embodiment, the network device in the present application includes a NG-RAN and an LMF.

In one embodiment, the network device in the present application includes a NG-RAN, an AMF and an LMF.

### Embodiment 6

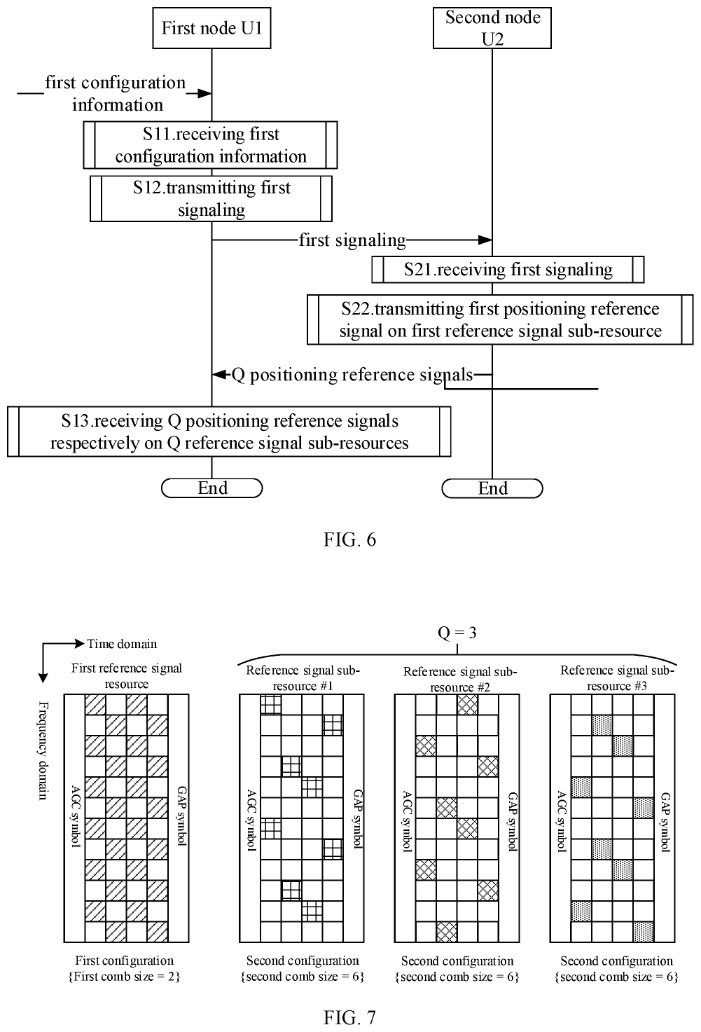

Embodiment 6 illustrates a flowchart of radio signal transmission according to one embodiment of the present application, as shown in FIG. 6. In FIG. 6, a first node U1 and a second node U2 are in communications via an air interface.

The first node U1 receives first configuration information in step S11; transmits a first signaling in step S12; and in step S13, receives Q positioning reference signals respectively on Q reference signal sub-resources, Q being a positive integer greater than 1.

The second node U2 receives a first signaling in step S21; and transmits a first positioning reference signal on a first reference signal sub-resource in step S22.

In Embodiment 6, the first configuration information is used for determining a first resource pool; the first resource pool comprises a first reference signal resource, the first reference signal resource using a first configuration; the first resource pool is associated with K1 candidate resource configurations, with the first configuration being one of the K1 candidate resource configurations, K1 being a positive integer greater than 1; any of the K1 candidate resource configurations comprises at least one of a comb size, a number of symbols, a number of frequency-domain resource blocks, a resource repetition factor or a number of REs; the first reference signal resource comprises multiple reference signal sub-resources, and at least one of the multiple reference signal sub-resources uses a second configuration, where a value of Q is used to determine the second configuration; any two reference signal sub-resources among the multiple reference signal sub-resources occupy REs that are different; any of the Q reference signal sub-resources is one of the multiple reference signal sub-resources comprised by the first reference signal resource, with the first reference signal sub-resource being one of the Q reference signal sub-resources; the first signaling carries a first identifier, the first identifier being associated with the first reference signal resource; the Q positioning reference signals are respectively transmitted by Q transmitters, where the second node U2 is one of the Q transmitters; the Q positioning reference signals are used to determine location information of the first node U1, where the first positioning reference signal is one of the Q positioning reference signals; the Q transmitters correspond to Q second-type identifiers, respectively, and the Q second-type identifiers are respectively used for determining the Q reference signal sub-resources in the first reference signal resource; the second node U2 corresponds to one of Q second-type identifiers, where the second-type identifier corresponding to the second node U2 among the Q second-type identifiers is used for determining the first reference signal sub-resource from the Q reference signal sub-resources.

In one embodiment, the first configuration comprises a first comb size, while the second configuration comprises a second comb size, where the second comb size is Q times the size of the first comb size.

In one embodiment, the first configuration comprises a first number of symbols, while the second configuration comprises a second number of symbols, where the first number of symbols is Q times the size of the second number of symbols.

In one embodiment, a number of REs occupied by the first reference signal resource is Q times the size of a number of REs occupied by any reference signal sub-resource of the Q reference signal sub-resources.

In one embodiment, at least one reference signal sub-resource among the multiple reference signal sub-resources comprised by the first resource pool uses a third configuration, the third configuration being one of the K1 candidate resource configurations, where the third configuration is different from the second configuration.

In one embodiment, the first positioning reference signal is one of the Q positioning reference signals.

In one embodiment, a transmitter of the first positioning reference signal is the second node U2.

In one embodiment, the Q transmitters include the second node U2.

In one embodiment, the second node U2 is one of the Q transmitters.

In one embodiment, the first node U1 and the second node U2 are in communication via a PC5 interface.

In one embodiment, the first node U1 transmits the location information of the first node U1 to the second node U2.

In one embodiment, the first node U1 transmits the location information of the first node U1 to the second node U2, and the second node U2 reports to a LMF the location information of the first node U1.

In one embodiment, the first node U1 reports to a LMF the location information of the first node U1.

In one embodiment, the first configuration information is used for indicating the first resource pool.

In one embodiment, the first configuration information comprises the first resource pool.

In one embodiment, the first configuration information is used for indicating time-domain resources occupied by the first resource pool.

In one embodiment, the first configuration information comprises time-domain resources occupied by the first resource pool.

In one embodiment, the first configuration information is used for indicating frequency-domain resources occupied by the first resource pool.

In one embodiment, the first configuration information comprises frequency-domain resources occupied by the first resource pool.

In one embodiment, the first configuration information is used for indicating the multiple time-frequency resource blocks comprised in the first resource pool.

In one embodiment, the first configuration information comprises the multiple time-frequency resource blocks comprised in the first resource pool.

In one embodiment, the first configuration information is used for indicating the multiple time-domain resource blocks comprised by the first resource pool in time domain.

In one embodiment, the first configuration information comprises the multiple time-domain resource blocks comprised by the first resource pool in time domain.

In one embodiment, the first configuration information is used for indicating the multiple frequency-domain resource blocks comprised by the first resource pool in frequency domain.

In one embodiment, the first configuration information comprises the multiple frequency-domain resource blocks comprised by the first resource pool in frequency domain.

In one embodiment, the first configuration information is preconfigured.

In one embodiment, the first configuration information is configured.

In one embodiment, the first configuration information is configured by a Higher Layer Signaling.

In one embodiment, the first configuration information comprises a Higher Layer Signaling.

In one embodiment, the first configuration information comprises a Radio Resource Control (RRC) layer signaling.

In one embodiment, the first configuration information comprises a Radio Resource Control-Information Element (RRC-IE).

In one embodiment, the first configuration information comprises a Multimedia Access Control (MAC) layer signaling.

In one embodiment, the first configuration information comprises a Physical Layer (PHY) signaling.

In one embodiment, the first configuration information comprises a piece of Downlink Control Information (DCI).

In one embodiment, the first configuration information comprises a piece of Sidelink Control Information (SCI).

In one embodiment, the first configuration information is a System Information Block (SIB).

In one embodiment, the first configuration information is a Positioning SIB (posSIB).

In one embodiment, the definition of the posSIB can be found in 3GPP TS38.331, Section 6.3.1a.

In one embodiment, the first configuration information is a SIB12.

In one embodiment, the definition of the SIB12 can be found in 3GPP TS38.331, Section 6.3.1.

In one embodiment, the first configuration information comprises Sidelink Positioning Configuration.

In one embodiment, the first configuration information comprises Sidelink Communication Configuration.

In one embodiment, the first configuration information comprises Sidelink Discovery Configuration.

In one embodiment, the first configuration information comprises a SL-ResourcePool.

In one embodiment, the definition of the SL-ResourcePool can be found in 3GPP TS38.331, Section 6.3.5.

In one embodiment, the first configuration information is used for determining the K1 candidate resource configurations.

In one embodiment, the first configuration information comprises the K1 candidate resource configurations.

In one embodiment, the first configuration information is used for indicating the K1 candidate resource configurations.

In one embodiment, the first resource pool is associated with the K1 candidate resource configurations.

In one embodiment, the K1 candidate resource configurations are associated with the first resource pool.

In one embodiment, the first configuration information is used for determining the first resource pool and the K1 candidate resource configurations.

In one embodiment, the first configuration information is used for indicating the first resource pool, where the K1 candidate resource configurations are associated with the first resource pool.

In one embodiment, any of the K1 candidate resource configurations comprises at least one of a comb size, a number of symbols, a number of frequency-domain resource blocks, a resource repetition factor or a number of REs.

In one embodiment, any of the K1 candidate resource configurations comprises a comb size.

In one embodiment, any of the K1 candidate resource configurations comprises a number of symbols.

In one embodiment, any of the K1 candidate resource configurations comprises a number of frequency-domain resource blocks.

In one embodiment, any of the K1 candidate resource configurations comprises a resource repetition factor.

In one embodiment, any of the K1 candidate resource configurations comprises a number of REs.

In one embodiment, the first configuration is a candidate resource configuration of the K1 candidate resource configurations.

In one embodiment, the second configuration is a candidate resource configuration of the K1 candidate resource configurations.

In one embodiment, the first configuration and the second configuration are candidate resource configurations among the K1 candidate resource configurations, respectively.

In one embodiment, the second configuration is different from the first configuration.

In one embodiment, a third configuration is a candidate resource configuration of the K1 candidate resource configurations.

In one embodiment, the first configuration, the second configuration and the third configuration are candidate resource configurations among the K1 candidate resource configurations, respectively.

In one embodiment, the third configuration is different from the second configuration.

In one embodiment, the third configuration is different from the first configuration.

In one embodiment, the third configuration comprises at least one of a third comb size, a third number of symbols, a third number of frequency-domain resource blocks, a third resource repetition factor or a third number of REs.

In one embodiment, the third configuration comprises the third comb size.

In one embodiment, the third configuration comprises the third number of symbols.

In one embodiment, the third configuration comprises the third number of frequency-domain resource blocks.

In one embodiment, the third configuration comprises the third resource repetition factor.

In one embodiment, the third configuration comprises the third number of REs.

In one embodiment, at least one reference signal sub-resource of the multiple reference signal sub-resources comprised by the first resource pool using the third configuration comprises that a comb size of the reference signal sub-resource of the multiple reference signal sub-resources is equal to the third comb size.

In one embodiment, at least one reference signal sub-resource of the multiple reference signal sub-resources comprised by the first resource pool using the third configuration comprises that a number of symbols of the reference signal sub-resource of the multiple reference signal sub-resources is equal to the third number of symbols.

In one embodiment, at least one reference signal sub-resource of the multiple reference signal sub-resources comprised by the first resource pool using the third configuration comprises that a number of frequency-domain resource blocks occupied by the reference signal sub-resource of the multiple reference signal sub-resources in frequency domain is equal to the third number of frequency-domain resource blocks.

In one embodiment, at least one reference signal sub-resource of the multiple reference signal sub-resources comprised by the first resource pool using the third configuration comprises that a resource repetition factor of the reference signal sub-resource of the multiple reference signal sub-resources in time domain is equal to the third resource repetition factor.

In one embodiment, at least one reference signal sub-resource of the multiple reference signal sub-resources comprised by the first resource pool using the third configuration comprises that a number of multiple REs comprised by the reference signal sub-resource of the multiple reference signal sub-resources is equal to the third number of REs.

### Embodiment 7

Embodiment 7 illustrates a schematic diagram illustrating a relation between a first reference signal resource and Q reference signal sub-resources according to one embodiment of the present application, as shown in FIG. 7. In FIG. 7, each rectangle marked with “AGC symbol” represents a multicarrier symbol used for Automatic Gain Control (AGC); each rectangle marked with “GAP symbol” represents a Guard Period; each slash-filled square represents an RE occupied by the first reference signal resource; each grid-filled square represents an RE occupied by a reference signal sub-resource#1; each cross-filled square represents an RE occupied by a reference signal sub-resource#2; each dot-filled square represents an RE occupied by a reference signal sub -resource#3.

In Embodiment 7, the first reference signal resource uses the first configuration, the first configuration comprising the first comb size; the first reference signal resource comprises Q reference signal sub-resources, where any of the Q reference signal sub-resources uses a second configuration, the second configuration comprising a second comb size; any two reference signal sub-resources among the Q reference signal sub-resources occupy REs that are different; a value of Q is used to determine the second comb size in the second configuration.

In one embodiment, the first reference signal resource comprises the Q reference signal sub-resources.

In one embodiment, any of the Q reference signal sub-resources is one of the multiple reference signal sub-resources comprised by the first reference signal resource.

In one embodiment, any of the Q reference signal sub-resources uses the second configuration.

In one embodiment, at least one of the Q reference signal sub-resources uses the second configuration.

In one embodiment, at least one of the Q reference signal sub-resources uses the second configuration, and at least one of the Q reference signal sub-resources uses the third configuration.

In one embodiment, among the multiple reference signal sub-resources in the first reference signal resource only the Q reference signal sub-resources use the second configuration.

In one embodiment, among the multiple reference signal sub-resources in the first reference signal resource only the Q reference signal sub-resources use the second configuration, while any reference signal sub-resource other than the Q reference signal sub-resources among the multiple reference signal sub-resources in the first reference signal resource uses the third configuration.

In one embodiment, Q is used for determining the second configuration.

In one embodiment, a value of Q is used for determining the second configuration.

In one embodiment, a value of Q is used to determine the second comb size in the second configuration.

In one embodiment, the first configuration is used together with the value of Q for determining the second configuration.

In one embodiment, the first configuration is used together with the value of Q for determining the second comb size in the second configuration.

In one embodiment, the first comb size in the first configuration is used together with the value of Q for determining the second comb size in the second configuration.

In one embodiment, the second comb size in the second configuration is no smaller than the first comb size in the first configuration.

In one embodiment, the second comb size in the second configuration is equal to the first comb size in the first configuration.

In one embodiment, the second comb size in the second configuration is larger than the first comb size in the first configuration.

In one embodiment, the second comb size in the second configuration is a multiple of the first comb size in the first configuration.

In one embodiment, the second comb size in the second configuration is Q times as much as the first comb size in the first configuration.

In one embodiment, the second comb size in the second configuration is a product of the first comb size in the first configuration and Q.

In one embodiment, Q is a modulus value of a quotient of the second comb size in the second configuration and the first comb size in the first configuration.

### Embodiment 8

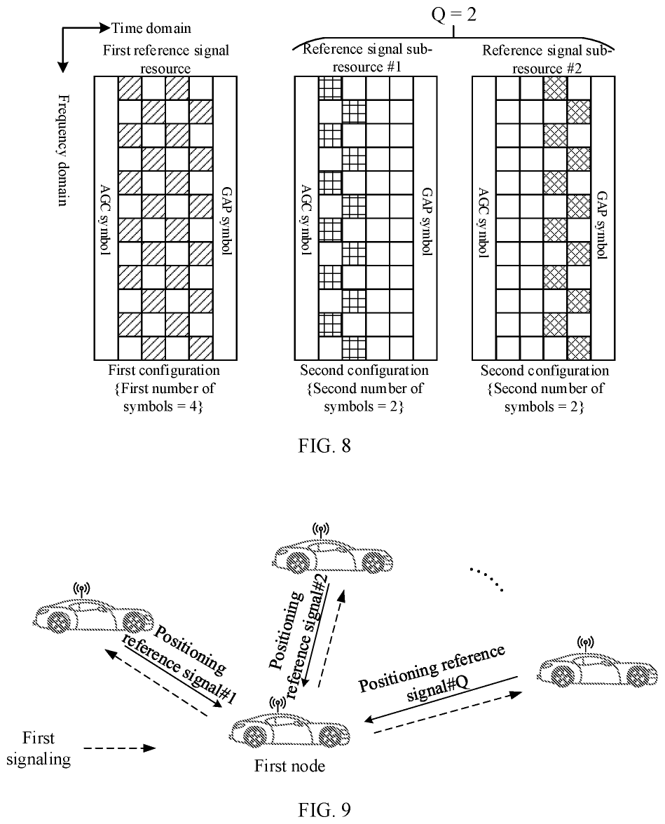

Embodiment 8 illustrates a schematic diagram illustrating a relation between a first reference signal resource and Q reference signal sub-resources according to one embodiment of the present application, as shown in FIG. 8. In FIG. 8, each rectangle marked with “AGC symbol” represents a multicarrier symbol used for Automatic Gain Control (AGC); each rectangle marked with “GAP symbol” represents a Guard Period; each slash-filled square represents an RE occupied by the first reference signal resource; each grid-filled square represents an RE occupied by a reference signal sub-resource#1; each cross-filled square represents an RE occupied by a reference signal sub-resource#2.

In Embodiment 8, the first reference signal resource uses the first configuration, the first configuration comprising the first number of symbols; the first reference signal resource comprises Q reference signal sub-resources, where any of the Q reference signal sub-resources uses a second configuration, the second configuration comprising a second number of symbols; any two reference signal sub-resources among the Q reference signal sub-resources occupy REs that are different; a value of Q is used to determine the second number of symbols in the second configuration.

In one embodiment, the first configuration is used together with the value of Q for determining the second number of symbols in the second configuration.

In one embodiment, the first number of symbols in the first configuration is used together with the value of Q for determining the second number of symbols in the second configuration.

In one embodiment, the second number of symbols in the second configuration is no greater than the first number of symbols in the first configuration.

In one embodiment, the second number of symbols in the second configuration is equal to the first number of symbols in the first configuration.

In one embodiment, the second number of symbols in the second configuration is less than the first number of symbols in the first configuration.

In one embodiment, the second number of symbols in the second configuration is a divisor of the first number of symbols in the first configuration.

In one embodiment, the first number of symbols in the first configuration is a multiple of the second number of symbols in the second configuration.

In one embodiment, the first number of symbols in the first configuration is Q times the size of the second number of symbols in the second configuration.

In one embodiment, the first number of symbols in the first configuration is a product of the second number of symbols in the second configuration and Q.

In one embodiment, Q is a modulus value of a quotient of the first number of symbols in the first configuration being divided by the second number of symbols in the second configuration.

In one embodiment, the first configuration is used together with the value of Q for determining the second number of REs in the second configuration.

In one embodiment, the first number of REs in the first configuration is used together with the value of Q for determining the second number of REs in the second configuration.

In one embodiment, the second number of REs in the second configuration is no greater than the first number of REs in the first configuration.

In one embodiment, the second number of REs in the second configuration is equal to the first number of REs in the first configuration.

In one embodiment, the second number of REs in the second configuration is less than the first number of REs in the first configuration.

In one embodiment, the second number of REs in the second configuration is a divisor of the first number of REs in the first configuration.

In one embodiment, the first number of REs in the first configuration is a multiple of the second number of REs in the second configuration.

In one embodiment, the first number of REs in the first configuration is Q times the size of the second number of REs in the second configuration.

In one embodiment, the first number of REs in the first configuration is a product of the second number of REs in the second configuration and Q.

In one embodiment, Q is a modulus value of a quotient of the first number of REs in the first configuration being divided by the second number of REs in the second configuration.

In one embodiment, a number of REs occupied by the first reference signal resource is the first number of REs.

In one embodiment, a number of REs occupied by any reference signal sub-resource of the Q reference signal sub-resources is the second number of REs.

In one embodiment, the first reference signal resource is used together with the value of Q for determining a number of REs occupied by any reference signal sub-resource of the Q reference signal sub-resources.

In one embodiment, a number of REs occupied by the first reference signal resource is used together with the value of Q for determining a number of REs occupied by any reference signal sub-resource of the Q reference signal sub-resources.

### Embodiment 9

Embodiment 9 illustrates a schematic diagram illustrating a relation between a first signaling and Q positioning reference signals according to one embodiment of the present application, as shown in FIG. 9. In FIG. 9, the dotted-line arrowhead indicates a first signaling in the present application; the solid-line arrow indicates any positioning reference signal among Q positioning reference signals in the present application.

In Embodiment 9, the first node transmits a first signaling, the first signaling carrying a first identifier, the first identifier being associated with the first reference signal resource; Q transmitters are receivers of the first signaling, and the Q transmitters respectively transmit Q positioning reference signals, the Q positioning reference signals being a positioning reference signal#1, a positioning reference signal#2 . . . , and a positioning reference signal#Q, respectively; the Q positioning reference signals respectively occupy the Q reference signal sub-resources in the first reference signal resource; the Q transmitters correspond to Q second-type identifiers, respectively, and the Q second-type identifiers are respectively used for determining the Q reference signal sub-resources in the first reference signal resource.

In one embodiment, the first signaling is used for indicating the first reference signal resource.

In one embodiment, the first signaling is used for indicating the configuration of the first reference signal resource.

In one embodiment, the first signaling is used for indicating a time-domain resource block to which the first reference signal resource belongs in time domain.

In one embodiment, the first signaling is used for determining the first reference signal resource from the first resource pool.

In one embodiment, the first signaling is used for determining the first reference signal resource out of multiple reference signal resources, where the first resource pool comprises the multiple reference signal resources, with the first reference signal resource being one of the multiple reference signal resources.

In one embodiment, the first signaling is used for carrying the first identifier.

In one embodiment, the first identifier is associated with the Q transmitters.

In one embodiment, the first identifier corresponds to the Q transmitters.

In one embodiment, the first identifier is used for indicating the Q transmitters.

In one embodiment, the Q transmitters all correspond to the first identifier.

In one embodiment, the first identifier is related to the first node U1.

In one embodiment, the first identifier is associated with the first reference signal resource.

In one embodiment, the configuration of the first reference signal resource is related to the first identifier.

In one embodiment, the first identifier is used to determine the first reference signal resource.

In one embodiment, the first identifier is used to determine an index of the first reference signal resource among the multiple reference signal resources.

In one embodiment, the first identifier is an index of the first reference signal resource among the multiple reference signal resources, where the first resource pool comprises the multiple reference signal resources.

In one embodiment, any two reference signal resources among the multiple reference signal resources share an identical configuration.

In one embodiment, the first identifier is a Group Identity (Group ID).

In one embodiment, the first identifier is a Destination Identity (ID).

In one embodiment, the first identifier is a Source Identity (ID).

In one embodiment, the first identifier is a positive integer.

In one embodiment, the first identifier is a Radio Network Temporary Identity (RNTI).

In one embodiment, the first signaling comprises a higher-layer signaling

In one embodiment, the first signaling comprises a physical-layer signaling

In one embodiment, the first signaling comprises an RRC layer signaling

In one embodiment, the first signaling comprises an SCI.

In one embodiment, the first signaling is an SCI.

In one embodiment, the first signaling is a 1st-stage SCI.

In one embodiment, the first signaling comprises a PSCCH.

In one embodiment, the first signaling is a PSCCH.

In one embodiment, the first signaling comprises a PSSCH.

In one embodiment, the first signaling is carried on a PSCCH.

In one embodiment, the first signaling is carried on a PSSCH.

In one embodiment, the first signaling is carried on a PSCCH and a PSSCH.

In one embodiment, the Q transmitters respectively correspond to the Q second-type identifiers.

In one embodiment, the Q second-type identifiers are respectively used for identifying the Q transmitters.

In one embodiment, any of the Q second-type identifiers is a Member ID.

In one embodiment, any of the Q second-type identifiers is related to the first identifier.

In one embodiment, the first identifier is used to determine any second-type identifier of the Q second-type identifiers.

In one embodiment, the first identifier is used to determine the Q second-type identifiers.

In one embodiment, the first identifier is associated with the Q second-type identifiers.

In one embodiment, the Q second-type identifiers are respectively Q Destination IDs.

In one embodiment, the Q second-type identifiers are respectively Q Source IDs.

In one embodiment, the Q second-type identifiers respectively correspond to the Q reference signal resources.

In one embodiment, the Q second-type identifiers are respectively associated with the Q reference signal resources.

In one embodiment, the Q second-type identifiers respectively determine the Q reference signal sub-resources from the first reference signal resource.

In one embodiment, any of the Q second-type identifiers is used for determining a reference signal sub-resource from the first reference signal resource.

In one embodiment, any of the Q second-type identifiers is used for determining a reference signal sub-resource out of the Q reference signal sub-resources comprised by the first reference signal resource.

In one embodiment, the Q second-type identifiers are respectively Q positive integers.

In one embodiment, the Q second-type identifiers are respectively Q RNTIs.

### Embodiment 10

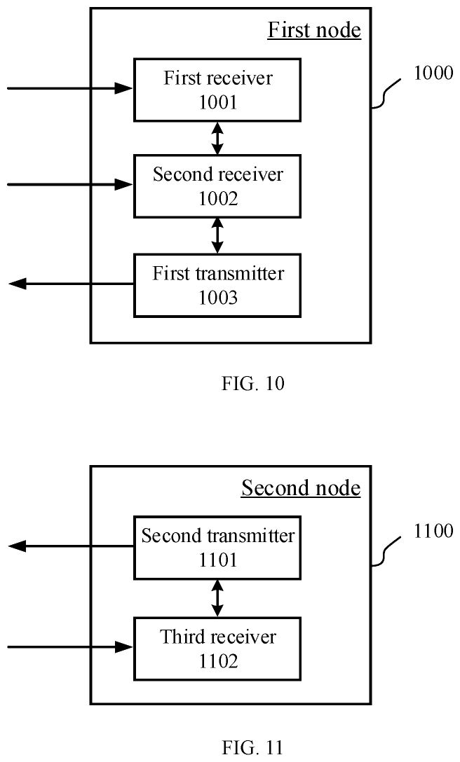

Embodiment 10 illustrates a structure block diagram of a processing device used in a first node, as shown in FIG. 10. In Embodiment 10, a processing device 1000 in a first node is comprised of a first receiver 1001, a second receiver 1002 and a first transmitter 1003.

In one embodiment, the first receiver 1001 comprises at least one of the antenna 452, the transmitter/receiver 454, the multi-antenna receiving processor 458, the receiving processor 456, the controller/processor 459, or the memory 460 in FIG. 4 of the present application.

In one embodiment, the second receiver 1002 comprises at least one of the antenna 452, the transmitter/receiver 454, the multi-antenna receiving processor 458, the receiving processor 456, the controller/processor 459, or the memory 460 in FIG. 4 of the present application.

In one embodiment, the first transmitter 1003 comprises at least one of the antenna 452, the transmitter/receiver 454, the multi-antenna transmitting processor 457, the transmitting processor 468, the controller/processor 459, the memory 460 or the data source 467 in FIG. 4 of the present application.

In Embodiment 10, the first receiver 1001 receives Q positioning reference signals respectively on Q reference signal sub-resources, Q being a positive integer greater than 1; a first resource pool comprises a first reference signal resource, the first reference signal resource using a first configuration; the first reference signal resource comprises multiple reference signal sub-resources, and at least one of the multiple reference signal sub-resources uses a second configuration, where Resource Elements (REs) occupied by any two reference signal sub-resources among the multiple reference signal sub-resources are different; any of the Q reference signal sub-resources is one of the multiple reference signal sub-resources comprised by the first reference signal resource; the Q positioning reference signals are respectively transmitted by Q transmitters; the Q positioning reference signals are used for determining location information of the first node; a value of Q is used to determine the second configuration.

In one embodiment, the second receiver 1002 receives first configuration information; the first configuration information is used for determining the first resource pool; the first configuration information is used for determining K1 candidate resource configurations, with the first configuration being one of the K1 candidate resource configurations; any of the K1 candidate resource configurations comprises at least one of a comb size, a number of symbols, a number of frequency-domain resource blocks, a resource repetition factor or a number of REs, where K1 is a positive integer greater than 1.

In one embodiment, the first configuration comprises a first comb size, while the second configuration comprises a second comb size, where the second comb size is Q times the size of the first comb size.

In one embodiment, the first configuration comprises a first number of symbols, while the second configuration comprises a second number of symbols, where the first number of symbols is Q times the size of the second number of symbols.

In one embodiment, a number of REs occupied by the first reference signal resource is Q times the size of a number of REs occupied by any reference signal sub-resource of the Q reference signal sub-resources.

In one embodiment, at least one reference signal sub-resource among the multiple reference signal sub-resources comprised by the first resource pool uses a third configuration, the third configuration being one of the K1 candidate resource configurations, where the third configuration is different from the second configuration.

In one embodiment, the first transmitter 1003 transmits a first signaling; the first signaling carries a first identifier, the first identifier being associated with the first reference signal resource; the Q transmitters correspond to Q second-type identifiers, respectively, and the Q second-type identifiers are respectively used for determining the Q reference signal sub-resources in the first reference signal resource.

In one embodiment, the first node 1000 is a UE.

In one embodiment, the first node 1000 is a relay node.

In one embodiment, the first node 1000 is an RSU.

### Embodiment 11

Embodiment 11 illustrates a structure block diagram of a processing device used in a second node according to one embodiment of the present application, as shown in FIG. 11. In Embodiment 11, a processing device 1100 in a second node is comprised of a second transmitter 1101 and a third receiver 1102.

In one embodiment, the second transmitter 1101 comprises at least one of the antenna 420, the transmitter/receiver 418, the multi-antenna transmitting processor 471, the transmitting processor 416, the controller/processor 475 or the memory 476 in FIG. 4 of the present application.

In one embodiment, the third receiver 1102 comprises at least one of the antenna 420, the transmitter/receiver 418, the multi-antenna receiving processor 472, the receiving processor 470, the controller/processor 475 or the memory 476 in FIG. 4 of the present application.

In Embodiment 11, the second transmitter 1101 transmits a first positioning reference signal on a first reference signal sub-resource; a first resource pool comprises a first reference signal resource, the first reference signal resource using a first configuration; the first reference signal resource comprises multiple reference signal sub-resources, and at least one of the multiple reference signal sub-resources uses a second configuration, where Resource Elements (REs) occupied by any two reference signal sub-resources among the multiple reference signal sub-resources are different; the first reference signal sub-resource is one of Q reference signal sub-resources, Q being a positive integer greater than 1, and any of the Q reference signal sub-resources is one of the multiple reference signal sub-resources comprised by the first reference signal resource; the Q reference signal sub-resources are respectively used for transmitting Q positioning reference signals, with the first positioning reference signal being one of the Q positioning reference signals; the Q positioning reference signals are used for determining location information of a target receiver of the first positioning reference signal; a value of Q is used to determine the second configuration.

In one embodiment, the first resource pool is associated with K1 candidate resource configurations, with the first configuration being one of the K1 candidate resource configurations; any of the K1 candidate resource configurations comprises at least one of a comb size, a number of symbols, a number of frequency-domain resource blocks, a resource repetition factor or a number of REs, where K1 is a positive integer greater than 1.

In one embodiment, the first configuration comprises a first comb size, while the second configuration comprises a second comb size, where the second comb size is Q times the size of the first comb size.

In one embodiment, the first configuration comprises a first number of symbols, while the second configuration comprises a second number of symbols, where the first number of symbols is Q times the size of the second number of symbols.

In one embodiment, a number of REs occupied by the first reference signal resource is Q times the size of a number of REs occupied by any reference signal sub-resource of the Q reference signal sub-resources.

In one embodiment, at least one reference signal sub-resource among the multiple reference signal sub-resources comprised by the first resource pool uses a third configuration, the third configuration being one of the K1candidate resource configurations, where the third configuration is different from the second configuration.

In one embodiment, the third receiver 1102 receives a first signaling; the first signaling carries a first identifier, the first identifier being associated with the first reference signal resource; the second node corresponds to one of Q second-type identifiers, where the second-type identifier corresponding to the second node among the Q second-type identifiers is used for determining the first reference signal sub-resource from the Q reference signal sub-resources.

In one embodiment, the second node 1100 is a UE.

In one embodiment, the second node 1100 is a relay node.

In one embodiment, the second node 1100 is an RSU.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The base station or network equipment in the present application includes but is not limited to macro-cellular base stations, micro-cellular base stations, home base stations, relay base station, eNB, gNB, Transmitter Receiver Point (TRP), GNSS, relay satellite, satellite base station, airborne base station and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, characterized in comprising:
a first receiver, receiving Q positioning reference signals respectively on Q reference signal sub-resources, Q being a positive integer greater than 1;
wherein a first resource pool comprises a first reference signal resource, the first reference signal resource using a first configuration; the first reference signal resource comprises multiple reference signal sub-resources, and at least one of the multiple reference signal sub-resources uses a second configuration, where Resource Elements (REs) occupied by any two reference signal sub-resources among the multiple reference signal sub-resources are different;
any of the Q reference signal sub-resources is one of the multiple reference signal sub-resources comprised by the first reference signal resource; the Q positioning reference signals are respectively transmitted by Q transmitters; the Q positioning reference signals are used for determining location information of the first node; a value of Q is used to determine the second configuration.

2. The first node according to claim 1, characterized in comprising:
a second receiver, receiving first configuration information;
wherein the first configuration information is used for determining the first resource pool; the first configuration information is used for determining K1 candidate resource configurations, with the first configuration being one of the K1 candidate resource configurations; any of the K1 candidate resource configurations comprises at least one of a comb size, a number of symbols, a number of frequency-domain resource blocks, a resource repetition factor or a number of REs.

3. The first node according to claim 1, characterized in that the first configuration comprises a first comb size, while the second configuration comprises a second comb size, where the second comb size is Q times the size of the first comb size.

4. The first node according to claim 3, characterized in that the first comb size is a number of subcarrier(s) between any two adjacent subcarriers occupied by the first reference signal resource in frequency domain; the second comb size is a number of subcarrier(s) between any two jacent subcarriers occupied by at least one reference signal sub-resource among the multiple reference signal sub-resources in frequency domain

5. The first node according to claim 1, characterized in that the first configuration comprises a first number of symbols, while the second configuration comprises a second number of symbols, where the first number of symbols is Q times the size of the second number of symbols.

6. The first node according to claim 5, characterized in that the first number of symbols is a number of symbols occupied by the first reference signal resource in time domain; the second number of symbols is a number of symbols occupied by at least one reference signal sub-resource among the multiple reference signal sub-resources in time domain

7. The first node according to claim 1, characterized in that a number of REs occupied by the first reference signal resource is Q times the size of a number of REs occupied by any reference signal sub-resource of the Q reference signal sub-resources.

8. The first node according to claim 2, characterized in that at least one reference signal sub-resource among the multiple reference signal sub-resources comprised by the first resource pool uses a third configuration, the third configuration being one of the K1 candidate resource configurations, where the third configuration is different from the second configuration.

9. The first node according to claim 1, characterized in comprising:
a first transmitter, transmitting a first signaling;
wherein the first signaling carries a first identifier, the first identifier being associated with the first reference signal resource; the Q transmitters correspond to Q second-type identifiers, respectively, and the Q second-type identifiers are respectively used for determining the Q reference signal sub-resources in the first reference signal resource.

10. The first node according to claim 1, characterized in that the first configuration comprises a first resource repetition factor, where a resource repetition factor of the first reference signal resource in time domain is equal to the first resource repetition factor in the first configuration; the second configuration comprises a second resource repetition factor, where a resource repetition factor of at least one reference signal sub-resource among the multiple reference signal sub-resources in time domain is equal to the second resource repetition factor; the second resource repetition factor in the second configuration is smaller than the first resource repetition factor in the first configuration.

11. A second node for wireless communications, characterized in comprising:
a second transmitter, transmitting a first positioning reference signal on a first reference signal sub-resource;
wherein a first resource pool comprises a first reference signal resource, the first reference signal resource using a first configuration; the first reference signal resource comprises multiple reference signal sub-resources, and at least one of the multiple reference signal sub-resources uses a second configuration, where REs occupied by any two reference signal sub-resources among the multiple reference signal sub-resources are different; the first reference signal sub-resource is one of Q reference signal sub-resources, Q being a positive integer greater than 1, and any of the Q reference signal sub-resources is one of the multiple reference signal sub-resources comprised by the first reference signal resource; the Q reference signal sub-resources are respectively used for transmitting Q positioning reference signals, with the first positioning reference signal being one of the Q positioning reference signals; the Q positioning reference signals are used for determining location information of a target receiver of the first positioning reference signal; a value of Q is used to determine the second configuration.

12. The second node according to claim 11, characterized in that the first resource pool is associated with K1 candidate resource configurations, with the first configuration being one of the K1 candidate resource configurations; any of the K1 candidate resource configurations comprises at least one of a comb size, a number of symbols, a number of frequency-domain resource blocks, a resource repetition factor or a number of REs, where K1 is a positive integer greater than 1.

13. The second node according to claim 11, characterized in that the first configuration comprises a first comb size, while the second configuration comprises a second comb size, where the second comb size is Q times the size of the first comb size.

14. The second node according to claim 13, characterized in that the first comb size is a number of subcarrier(s) between any two adjacent subcarriers occupied by the first reference signal resource in frequency domain; the second comb size is a number of subcarrier(s) between any two jacent subcarriers occupied by at least one reference signal sub-resource among the multiple reference signal sub-resources in frequency domain

15. The second node according to claim 11, characterized in that the first configuration comprises a first number of symbols, while the second configuration comprises a second number of symbols, where the first number of symbols is Q times the size of the second number of symbols.

16. The second node according to claim 15, characterized in that the first number of symbols is a number of symbols occupied by the first reference signal resource in time domain; the second number of symbols is a number of symbols occupied by at least one reference signal sub-resource among the multiple reference signal sub-resources in time domain

17. The second node according to claim 11, characterized in that a number of REs occupied by the first reference signal resource is Q times the size of a number of REs occupied by any reference signal sub-resource of the Q reference signal sub-resources.

18. The second node according to claim 12, characterized in that at least one reference signal sub-resource among the multiple reference signal sub-resources comprised by the first resource pool uses a third configuration, the third configuration being one of the K1 candidate resource configurations, where the third configuration is different from the second configuration.

19. The second node according to claim 11, characterized in comprising:
a third receiver, receiving a first signaling;
wherein the first signaling carries a first identifier, the first identifier being associated with the first reference signal resource; the Q transmitters correspond to Q second-type identifiers, respectively, and the Q second-type identifiers are respectively used for determining the Q reference signal sub-resources in the first reference signal resource.

20. A method in a first node for wireless communications, characterized in comprising:
receiving Q positioning reference signals respectively on Q reference signal sub-resources, Q being a positive integer greater than 1;
wherein a first resource pool comprises a first reference signal resource, the first reference signal resource using a first configuration; the first reference signal resource comprises multiple reference signal sub-resources, and at least one of the multiple reference signal sub-resources uses a second configuration, where Resource Elements (REs) occupied by any two reference signal sub-resources among the multiple reference signal sub-resources are different; any of the Q reference signal sub-resources is one of the multiple reference signal sub-resources comprised by the first reference signal resource; the Q positioning reference signals are respectively transmitted by Q transmitters; the Q positioning reference signals are used for determining location information of the first node; a value of Q is used to determine the second configuration.
